(19) United States
(12) Patent Application Publication
(10) Pub. No.: US 2024/0051789 A1
(43) Pub. Date: Feb. 15, 2024

(54) GUIDANCE SYSTEM

(71) Applicant: Mitsubishi Electric Corporation, Tokyo (JP)

(72) Inventors: Ryu MAKABE, Tokyo (JP); Masami AIKAWA, Tokyo (JP); Kei GOMITA, Tokyo (JP); Atsushi HORI, Tokyo (JP); Seiji FUWA, Tokyo (JP)

(73) Assignee: Mitsubishi Electric Corporation, Tokyo (JP)

(21) Appl. No.: 18/271,241

(22) PCT Filed: Jan. 5, 2022
(86) PCT No.: PCT/JP2022/000109

§ 371 Date: Jul. 7, 2023

(30) Foreign Application Priority Data
Jan. 13, 2021 (WO) PCT/JP2021/000916

(51) Int. Cl. B66B 1/34

(52) U.S. Cl. CPC B66B 1/3461

(57) ABSTRACT

There is provided a guidance system capable of guiding a user who does not operate an ascending/descending facility in a building as well on the basis of concern and interest of the user. In a guidance system (1), a behavior information acquisition unit (15) acquires behavior information on an arrival floor of a user. An interest information acquisition unit (20) acquires interest information representing a degree of interest of the user for each attribute on the basis of a relationship between layout and attributes of areas on the arrival floor and the behavior information. A destination presentation unit (22) preferentially presents an area with an attribute with a higher degree of interest as a destination when a user specification unit (14) specifies a user, on the basis of the interest information for the user and information on attributes for each area.

### FIELD

The present disclosure relates to a guidance system.

### BACKGROUND

PTL 1 discloses an example of a destination floor registration device of an elevator. In the destination floor registration device, candidates for a destination floor are selected on the basis of accumulated use history for each user.

### CITATION LIST

### Patent Literature

[PTL 1] JP 2012-224423 A

### SUMMARY

### Technical Problem

However, in the destination floor registration device in PTL 1, the use history of the user is acquired through operation of equipment of the elevator by the user. Thus, the destination floor registration device cannot acquire information on interest such as a destination floor, of a user who does not operate an ascending/descending facility such as an elevator provided in a building. Thus, the destination floor registration device cannot perform guidance such as presentation of a destination floor in the building for the user who does not operate the ascending/descending facility provided in the building on the basis of the interest of the user.

The present disclosure has been made to solve such a problem. The present disclosure provides a guidance system capable of guiding a user who does not operate an ascending/descending facility in a building as well on the basis of concern and interest of the user.

### Solution to Problem

A guidance system according to the present disclosure includes: an attribute storage unit configured to store attributes for each area for each of a plurality of floors of a building; a user specification unit configured to specify a user in the building on a basis of an image captured by at least one of a plurality of cameras provided in the building; a floor judgement unit configured to, when the user specified by the user specification unit moves from a departure floor to an arrival floor among the plurality of floors by utilizing one of one or more ascending/descending facilities provided in the building, judge the arrival floor of the user on a basis of an image captured by at least one of the plurality of cameras; a behavior information acquisition unit configured to acquire behavior information representing behavior of the user on the arrival floor judged by the floor judgement unit on a basis of an image captured by one of the plurality of cameras for the user specified by the user specification unit; an interest information acquisition unit configured to acquire interest information representing a degree of interest of the user for each attribute on a basis of a relationship between layout and attributes of areas on the arrival floor judged by the floor judgement unit and the behavior information acquired by the behavior information acquisition unit for the user specified by the user specification unit; an interest information storage unit configured to store the interest information acquired by the interest information acquisition unit for each user; and a destination presentation unit configured to, when the user specification unit specifies a user who starts utilization of one of the one or more ascending/descending facilities, preferentially present an area with an attribute with a higher degree of interest to the user as a destination on a basis of the interest information stored in the interest information storage unit for the user and information on the attributes stored in the attribute storage unit.

A guidance system according to the present disclosure includes: a first attribute storage unit configured to store attributes for each area for each of a plurality of floors of a first building; a first user specification unit configured to specify a user in the first building on a basis of an image captured by at least one of a plurality of first cameras provided in the first building; a floor judgement unit configured to, when the user specified by the first user specification unit moves from a departure floor to an arrival floor among the plurality of floors of the first building by utilizing one of one or more ascending/descending facilities provided in the first building, judge the arrival floor of the user on a basis of an image captured by at least one of the plurality of cameras; a behavior information acquisition unit configured to acquire behavior information representing behavior of the user on the arrival floor judged by the floor judgement unit on a basis of an image captured by at least one of the plurality of first cameras for the user specified by the first user specification unit; an interest information acquisition unit configured to acquire interest information representing a degree of interest of the user for each attribute on a basis of a relationship between layout and attributes of areas on the arrival floor judged by the floor judgement unit and the behavior information acquired by the behavior information acquisition unit for the user specified by the first user specification unit; an interest information storage unit configured to store the interest information acquired by the interest information acquisition unit for each user; a second attribute storage unit configured to store attributes for each area for each of a plurality of floors of a second building; a second user specification unit configured to specify a user in the second building on a basis of an image captured by at least one of a plurality of second cameras provided in the second building; and a destination presentation unit configured to, when the second user specification unit specifies a user who starts utilization of one of one or more ascending/descending facilities provided in the second building, preferentially present an area with an attribute with a higher degree of interest for the user to the user as a destination in the second building by utilizing one or both of the interest information acquired in the first building and the interest information acquired in the second building, on a basis of the interest information stored in the interest information storage unit for the user and information on the attributes stored in the second attribute storage unit.

A guidance system according to the present disclosure includes: an attribute storage unit configured to store attributes for each area for each of a plurality of floors of a first building; a first user specification unit configured to specify a user in the first building on a basis of an image captured by at least one of a plurality of first cameras provided in the first building; a floor judgement unit configured to, when the user specified by the first user specification unit moves from a departure floor to an arrival floor among the plurality of floors of the first building by utilizing one of one or more ascending/descending facilities provided in the first building, judge the arrival floor of the user on a basis of an image captured by at least one of the plurality of first cameras; a behavior information acquisition unit configured to acquire behavior information representing behavior of the user on the arrival floor judged by the floor judgement unit on a basis of an image captured by at least one of the plurality of first cameras for the user specified by the first user specification unit; an interest information acquisition unit configured to acquire interest information representing a degree of interest of the user for each attribute on a basis of a relationship between layout and attributes of areas on the arrival floor judged by the floor judgement unit and the behavior information acquired by the behavior information acquisition unit for the user specified by the first user specification unit; an interest information storage unit configured to store the interest information acquired by the interest information acquisition unit for each user; a reception unit configured to receive an image of a user who starts utilization of one of one or more ascending/descending facilities provided in a third building from an external system comprising a storage unit configured to store and update each of a plurality of floors of the third building, the external system presenting a destination in accordance with a degree of interest of the user in the third building; a third user specification unit configured to specify a user on a basis of the image received by the reception unit; and a transmission unit configured to transmit a candidate with a high degree of interest stored in the interest information storage unit as interest information for the user to the external system for the user specified by the third user specification unit.

### Advantageous Effects of Invention

According to a guidance system according to the present disclosure, it is possible to guide a user who does not operate an ascending/descending facility in a building as well on the basis of interest of the user.

### BRIEF DESCRIPTION OF DRAWINGS

FIG. 1 is a configuration diagram of a guidance system according to Embodiment 1.

FIG. 2 is a view illustrating an example of the car operating panel according to Embodiment 1.

FIG. 3 is a view illustrating an example of areas on the floor according to Embodiment 1.

FIG. 4A is a view illustrating an example of layout of the cameras according to Embodiment 1.

FIG. 4B is a view illustrating an example of layout of the cameras according to Embodiment 1.

FIG. 4C is a view illustrating an example of layout of the cameras according to Embodiment 1.

FIG. 5A is a view illustrating an example of the behavior information acquired by the behavior information acquisition unit according to Embodiment 1.

FIG. 5B is a view illustrating an example of the behavior information acquired by the behavior information acquisition unit according to Embodiment 1.

FIG. 5C is a view illustrating an example of the behavior information acquired by the behavior information acquisition unit according to Embodiment 1.

FIG. 5D is a view illustrating an example of the behavior information acquired by the behavior information acquisition unit according to Embodiment 1.

FIG. 5E is a view illustrating an example of the behavior information acquired by the behavior information acquisition unit according to Embodiment 1.

FIG. 6 is a table indicating an example of judgement by the floor judgement unit according to Embodiment 1.

FIG. 7A is a view illustrating an example of judgement by the floor judgement unit according to Embodiment 1.

FIG. 7B is a view illustrating an example of judgement by the floor judgement unit according to Embodiment 1.

FIG. 7C is a view illustrating an example of judgement by the floor judgement unit according to Embodiment 1.

FIG. 7D is a view illustrating an example of judgement by the floor judgement unit according to Embodiment 1.

FIG. 7E is a view illustrating an example of judgement by the floor judgement unit according to Embodiment 1.

FIG. 7F is a view illustrating an example of judgement by the floor judgement unit according to Embodiment 1.

FIG. 8 is a view illustrating an example of acquisition of the behavior information by the guidance system according to Embodiment 1.

FIG. 9A is a view illustrating an example of acquisition of the behavior information by the guidance system according to Embodiment 1.

FIG. 9B is a view illustrating an example of acquisition of the behavior information by the guidance system according to Embodiment 1.

FIG. 10A is a view illustrating an example of acquisition of the interest information by the guidance system according to Embodiment 1.

FIG. 10B is a view illustrating an example of acquisition of the interest information by the guidance system according to Embodiment 1.

FIG. 10C is a view illustrating an example of acquisition of the interest information by the guidance system according to Embodiment 1.

FIG. 11A is a view illustrating an example of presentation of the destination by the guidance system according to Embodiment 1.

FIG. 11B is a view illustrating an example of presentation of the destination by the guidance system according to Embodiment 1.

FIG. 12A is a view illustrating an example of presentation of the destination by the guidance system according to Embodiment 1.

FIG. 12B is a view illustrating an example of presentation of the destination by the guidance system according to Embodiment 1.

FIG. 13 is a flowchart illustrating an example of the operation of the guidance system according to Embodiment 1.

FIG. 14 is a flowchart illustrating an example of the operation of the guidance system according to Embodiment 1.

FIG. 15A is a flowchart illustrating an example of the operation of the guidance system according to Embodiment 1.

FIG. 15B is a flowchart illustrating an example of the operation of the guidance system according to Embodiment 1.

FIG. 16 is a hardware configuration diagram of main portions of the guidance system according to Embodiment 1.

FIG. 17A is a view illustrating an example of presentation of the destination by the guidance system according to Embodiment 2.

FIG. 17B is a view illustrating an example of presentation of the destination by the guidance system according to Embodiment 2.

FIG. 17C is a view illustrating an example of presentation of the destination by the guidance system according to Embodiment 2.

FIG. 18A is a view illustrating an example of presentation of the destination by the guidance system according to Embodiment 2.

FIG. 18B is a view illustrating an example of presentation of the destination by the guidance system according to Embodiment 2.

FIG. 19 is a configuration diagram of the guidance system according to Embodiment 3.

FIG. 20 is a view illustrating an example of presentation of the destination by the guidance system according to Embodiment 3.

FIG. 21 is a configuration diagram of the guidance system according to Embodiment 4.

FIG. 22 is a view illustrating an example of provision of the interest information by the guidance system according to Embodiment 4.

FIG. 23 is a configuration diagram of the guidance system according to Embodiment 5.

FIG. 24 is a view illustrating an example of presentation of the destination by the guidance system according to Embodiment 5.

FIG. 25A is a flowchart illustrating an example of the operation of the guidance system according to Embodiment 5.

FIG. 25B is a flowchart illustrating an example of the operation of the guidance system according to Embodiment 5.

FIG. 26 is a configuration diagram of the guidance system according to Embodiment 6.

FIG. 27 is a view illustrating an example of presentation of the destination by the guidance system according to Embodiment 6.

FIG. 28 is a configuration diagram of the guidance system according to Embodiment 7.

### DESCRIPTION OF EMBODIMENTS

Embodiments for implementing the present disclosure will be described with reference to the accompanying drawings. In each drawing, the same reference numerals will be assigned to the same or corresponding portions, and overlapping description will be simplified or omitted as appropriate.

### Embodiment 1

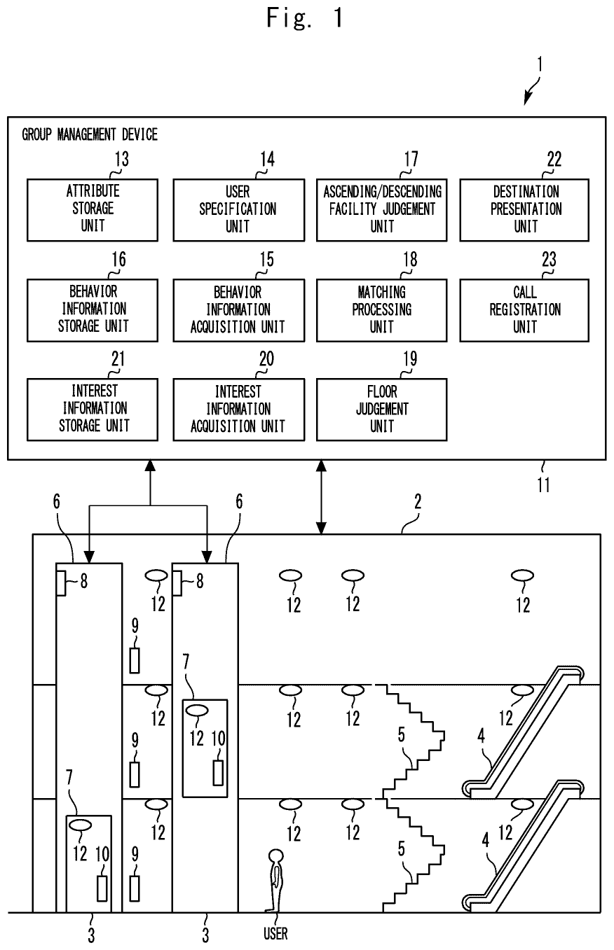

FIG. 1 is a configuration diagram of a guidance system 1 according to Embodiment 1.

The guidance system 1 is applied to a building 2 including a plurality of floors. The guidance system 1 is, for example, a system that guides a user, or the like, of the building 2 through presentation of a destination floor, and the like.

In the building 2, one or more ascending/descending facilities are provided. The ascending/descending facility is a facility to be utilized by the user of the building 2 to move between the plurality of floors. In the building 2 in this example, a plurality of ascending/descending facilities are provided. The ascending/descending facilities include, for example, an elevator 3, an escalator 4, stairs 5, and the like. On each floor of the building 2, a landing entrance of the stairs 5 is provided. A user who moves from a departure floor to an arrival floor by utilizing the stairs 5 starts utilization of the stairs 5 from the landing entrance on the departure floor. Then, the user completes utilization of the stairs 5 at the landing entrance on the arrival floor. Note that the stairs 5 may be a slope that is inclined between floors.

In this example, a plurality of elevators 3 are applied to the building 2 as the ascending/descending facilities. Each elevator 3 is a conveyance device that transports the user between the plurality of floors. In the building 2, a hoistway 6 of the elevator 3 is provided. The hoistway 6 is a space across the plurality of floors. On each floor of the building 2, a hall of the elevator 3 is provided. The hall of the elevator 3 is a space adjacent to the hoistway 6. Each elevator 3 includes a car 7, a control panel 8, and a hall operating panel 9. The car 7 is a device that transports the user who is inside the car 7 between the plurality of floors by traveling up and down through the hoistway 6. The car 7 includes a car operating panel 10. The car operating panel 10 is a device that accepts operation by the user who designates a destination floor of the car 7. The control panel 8 is, for example, a device that controls traveling, or the like, of the car 7 in accordance with call registered in the elevator 3. The hall operating panel 9 is a device that accepts operation by the user who registers call in the elevator 3. The hall operating panel 9 is, for example, provided at a hall on each floor. The hall operating panel 9 may be shared among the plurality of elevators 3. The user who moves from the departure floor to the arrival floor by utilizing the elevator 3 registers call, for example, by operating the hall operating panel 9 at the hall on the departure floor. The user starts utilization of the elevator 3 by getting on the car 7 from the hall on the departure floor. Then, the user completes utilization of the elevator 3 by getting off the car 7 at the hall on the arrival floor. In the building 2 in this example, a group management device 11 that manages operation such as assignment of call to the plurality of elevators 3 is provided. Here, in the building 2, equipment as an alternative to the group management device as independent equipment, equipment in which software having functions of the group management device is installed as independent equipment, or the like, may be provided. Some or all of functions of data processing regarding management of operation, and the like, may be installed on the control panel 8. Alternatively, some or all of functions of data processing regarding management of operation, and the like, may be installed on a server device, or the like, that can perform communication with each elevator 3. The server device may be provided either inside or outside of the building 2. Further, some or all of functions of data processing regarding management of operation, and the like, may be installed on virtual machine on a cloud service that can perform communication with each elevator 3. Some or all of functions of data processing regarding management of operation, and the like, may be implemented by dedicated hardware, or may be implemented by software or may be implemented using dedicated hardware and software in combination. Each means for performing data processing regarding management of operation, and the like, described above as examples will be hereinafter referred to as the group management device 11 regardless of its configuration.

The escalator 4 is built between an upper floor and a lower floor. The escalator 4 is a conveyance device that transports a user between the upper floor and the lower floor. On each floor of the building 2, a landing entrance of the escalator 4 is provided. A user who moves from a departure floor to an arrival floor by utilizing one or more escalators 4 starts utilization of the escalator 4 from an entrance on the departure floor. The user may transfer a plurality of escalators 4 between the departure floor and the arrival floor. Then, the user completes utilization of the escalator 4 at an exit on the arrival floor.

In the building 2, a plurality of cameras 12 are provided. Each camera 12 is a device that captures an image at a location where the camera is provided. An image to be captured by each camera 12 includes, for example, a still image and a moving image. A format of the image to be captured by each camera 12 may be, for example, a format of a compressed image such as Motion JPEG, AVC and HEVC. Alternatively, the format of the image to be captured by each camera 12 may be a format of a non-compressed image. Each camera 12 has a function of outputting the captured image to external equipment. In this example, the respective cameras 12 synchronize with each other so as to be able to acquire images captured at the same time as images at the same time point.

In this example, the plurality of cameras 12 include a camera 12 provided on each floor. The plurality of cameras 12 include a camera 12 provided inside the car 7 of the elevator 3. The plurality of cameras 12 include a camera 12 provided at the landing entrance of the escalator 4. The plurality of cameras 12 include a camera 12 provided at the landing entrance of the stairs 5. The plurality of cameras 12 may include a camera 12 provided outside such as an entrance, a periphery and a courtyard of the building 2 in a similar manner to the camera 12 provided on each floor. The plurality of cameras 12 may include a camera 12 provided at the hall of the elevator 3 in a similar manner to the camera 12 provided on each floor. The plurality of cameras 12 may include a camera 12 provided at a portion before the landing entrance of the escalator 4 in a similar manner to the camera 12 provided at the landing entrance of the escalator 4. The plurality of cameras 12 may include a camera 12 provided at a portion before the landing entrance of the stairs 5 in a similar manner to the camera 12 provided at the landing entrance of the stairs 5.

The guidance system 1 may include some or all of the plurality of cameras 12. Alternatively, some or all of the plurality of cameras 12 may be external devices of the guidance system 1. The guidance system 1 performs guidance through data processing based on the image acquired from each camera 12. The guidance system 1 includes an attribute storage unit 13, a user specification unit 14, a behavior information acquisition unit 15, a behavior information storage unit 16, an ascending/descending facility judgement unit 17, a matching processing unit 18, a floor judgement unit 19, an interest information acquisition unit 20, an interest information storage unit 21, a destination presentation unit 22 and a call registration unit 23 as parts that perform data processing. In this example, the parts that perform data processing in the guidance system 1 are installed on the group management device 11. Here, some or all of the parts that perform data processing in the guidance system 1 may be installed on an external server device, or the like, which is different from the group management device 11 and which can perform communication. Further, some or all of the parts that perform data processing in the guidance system 1 may be installed on an external server device, or the like, which is different from the server device provided in the building 2 and which can perform communication. Still further, some or all of the parts that perform data processing in the guidance system 1 may be installed on virtual machine, or the like, that can perform communication on a cloud service.

The attribute storage unit 13 is a portion that stores information. In the attribute storage unit 13, an attribute for each area of each floor of the building 2 is stored. The area of each floor is a portion which is part or all of the floor. The area of each floor is, for example, a portion, or the like, to be occupied by a tenant of the floor. The area of each floor may be, for example, a portion of a store, or the like, that is open on the floor. The attribute storage unit 13 stores information for specifying an area, for example, as a range of coordinates or the like on each floor. The area is not limited to a two-dimensional plane and may be, for example, a high-dimensional space such as a three-dimensional space. Further, the attribute of the area represents one or more objects and events. For example, in a case where the area is a store, the attribute of the area is a type of the store, a type of an article or a service dealt with at the store, or the like. For example, in a case where the area is a store, the attribute of the area may be name of the store, name of an article or a service dealt with at the store, or the like. Each area may have a plurality of attributes. One or more attributes of each area may be provided by a person or may be provided using artificial intelligence (AI).

The user specification unit 14 has a function of specifying a user of the building 2 on the basis of an image captured by at least one camera 12. The user specification unit 14 specifies a user, for example, by checking face information of the user extracted from the image against, if any, existing information through two-dimensional face authentication and settles specification of the user. In a case where the user is a new user, or the like, for whom there is no existing information, the user specification unit 14 may newly register face information of the user extracted from the image. Here, for example, characteristics of the nose, ears, eyes, mouth, cheek, jaw, neck, and the like, in the face are utilized as the face information. Further, to prevent abuse of the face information, the user specification unit 14 may acquire, for example, information on the iris, pupils, or the like, of the eyes. In a case where the pupils of the eyes do not have a shape of a circle, ellipse or the like and have concavities and convexities, the user specification unit 14 may detect a risk that false face information created through AI, or the like, has been acquired and may issue an alert, or the like.

The behavior information acquisition unit 15 has a function of acquiring behavior information of the user specified by the user specification unit 14. The behavior information of the user is, for example, time-series data of information representing layout of the user. The behavior information is not limited to three-dimensional information combining a two-dimensional plane and a time axis and may be, for example, higher-dimensional information combining a high-dimensional space such as a three-dimensional space and a time axis. The layout of the user includes, for example, information on a floor on which the user is located, a coordinate of the user on the floor, orientation of the user, and the like. The layout of the user may include information for specifying the ascending/descending facility in a case where the user utilizes one of the ascending/descending facilities. The behavior information as time-series data includes, for example, information on layout of the user acquired for each time interval set in advance. The behavior information acquisition unit 15 acquires the behavior information of the user on the basis of the image captured by at least one camera 12. The behavior information acquisition unit 15 continuously updates the behavior information of the user, for example, for each time interval set in advance.

The behavior information storage unit 16 is a part that stores information. The behavior information storage unit 16 stores the behavior information acquired by the behavior information acquisition unit 15 for each user specified by the user specification unit 14. In this example, the behavior information storage unit 16 stores identification information unique to the user necessary for specification by the user specification unit 14 and the behavior information of the user in association with each other.

The ascending/descending facility judgement unit 17 has a function of judging an ascending/descending facility to be utilized by the user specified by the user specification unit 14. The ascending/descending facility judgment unit 17 judges the ascending/descending facility that is to be utilized on the basis of the image captured by at least one camera 12. For example, when the user starts utilization of one of the ascending/descending facilities on the departure floor, the ascending/descending facility judgment unit 17 judges the ascending/descending facility as the ascending/descending facility to be utilized by the user.

The matching processing unit 18 has a function of achieving matching between specification of the user by the user specification unit 14 and judgement of the ascending/descending facility to be utilized by the user by the ascending/descending facility judgement unit 17. Processing of achieving matching is performed, for example, as follows. There is a possibility that the user specification unit 14 may erroneously specify different users as the same user. In this case, there is a possibility that the ascending/descending facility judgement unit 17 may judge two or more ascending/descending facilities as the ascending/descending facility to be utilized by the user at the same time for the users specified as the same user by the user specification unit 14. The same person cannot redundantly utilize two or more ascending/descending facilities at the same time, and thus, the matching processing unit 18 requests modification of specification of the user to the user specification unit 14. In this event, the user specification unit 14 specifies the users erroneously specified as the same user, as users different from each other. When the user specification unit 14 specifies the users as users different from each other, the user specification unit 14 extracts a difference in feature amounts of the users from the acquired image, improves accuracy of specification of the user and resettles specification of the users different from each other. The user specification unit 14 may perform adjustment by, for example, narrowing down a range of feature amounts judged as the same user in accordance with the extracted difference in feature amounts. The user specification unit 14 may improve accuracy of specification of the user on the basis of the extracted difference in feature amounts using other methods.

The floor judgement unit 19 has a function of judging an arrival floor of the user specified by the user specification unit 14. The arrival floor of the user is a floor on which the user who utilizes the ascending/descending facility completes utilization of the ascending/descending facility. For example, in a case where the user utilizes the elevator 3, the arrival floor of the user is a floor on which the user gets off the elevator 3. The floor judgment unit 19 judges the arrival floor on the basis of the image captured by at least one camera 12. For example, when the user completes utilization of the ascending/descending facility on one of the floors, the floor judgement unit 19 judges the floor as the arrival floor of the user.

The interest information acquisition unit 20 has a function of acquiring interest information of the user specified by the user specification unit 14. The interest information of the user is information representing a degree of interest of the user for each attribute assigned to the area. The interest information acquisition unit 20 acquires interest information on the basis of behavior of the user on the arrival floor. Here, the behavior of the user includes information such as, for example, a period during which the user stays on the arrival floor and a concern direction which is a direction in which the user shows interest on the arrival floor. In this example, the interest information acquisition unit 20 acquires interest information on the basis of the behavior of the user analyzed by the information stored in the attribute storage unit 13, and the behavior information acquired by the behavior information acquisition unit 15 or the behavior information stored in the behavior information storage unit 16. The interest information represents whether or not the user has interest as one element and represents a level of interest as the other element. The level of interest is analyzed using one or both of a period during which the user shows concern in an attribute assigned to the area located in the concern direction and a period during which the user stays, as elements. The interest information acquisition unit 20 adds information every time information from each floor is added to each user. The interest information acquisition unit 20 accordingly sorts levels of interest obtained as a result of analysis based on the updated information in order of priority.

The interest information storage unit 21 is a part that stores information. In the interest information storage unit 21, the interest information is stored for each user. In this example, the interest information storage unit 21 stores the interest information of the user, information on a time point and a location at which the interest information is acquired and whether or not a destination may be presented on the basis of the interest information, in association with identification information unique to the user. In this example, an initial value of whether or not a destination may be presented is a value indicating that a destination may be presented.

The destination presentation unit 22 has a function of presenting a destination to the user on the basis of the interest information stored in the interest information storage unit 21. The destination presentation unit 22, for example, presents an area having an attribute with a high degree of interest of the user to the user as the destination. Information on the destination to be presented by the destination presentation unit 22 includes, for example, an attribute of the destination, a destination floor which is a floor including the destination, a route to the destination from a current position of the user, and the like. The destination presentation unit 22 performs presentation to the user, for example, using a video. The video to be displayed by the destination presentation unit 22 includes, for example, characters, a still image, an image, and the like. The video may be, for example, a two-dimensional video displayed by display equipment such as a display, projection equipment such as a projector, or the like. Alternatively, the video may be a spatial video displayed in a three-dimensional manner. The video is displayed, for example, inside the car 7 of the elevator 3, at the hall of the elevator 3, at the landing entrance of the escalator 4, at the landing entrance of the stairs 5, or the like. Further, the display equipment may be, for example, a light indicating a destination, a liquid crystal display, an organic electro-luminescence (organic EL) display, a light-emitting film, a light emitting diode (LED) display, a projector, a stereoscopic (3D) display, or the like. Alternatively, the destination presentation unit 22 may perform presentation to the user using, for example, a speech. Equipment that emits a speech such as a speaker is provided, for example, inside the car 7 of the elevator 3, at the hall of the elevator 3, at the landing entrance of the escalator 4, at the landing entrance of the stairs 5, or the like.

The call registration unit 23 has a function of registering call to the destination floor presented by the destination presentation unit 22 in the elevator 3 for which the user starts utilization. Here, the call registration unit 23 may judge whether or not to register call to the destination floor presented to the user in accordance with order of priority analyzed using behavior of the user in response to the presentation, that is, using part or all of the period during which the user stays, whether or not the user has interest, and a level of interest as elements. The call registration unit 23, for example, registers the call in the elevator 3 on which the user is gets on the car 7. In a case where the call registration unit 23 is an external device of the group management device 11, the call registration unit 23 may input control information for registering the call to the group management device 11.

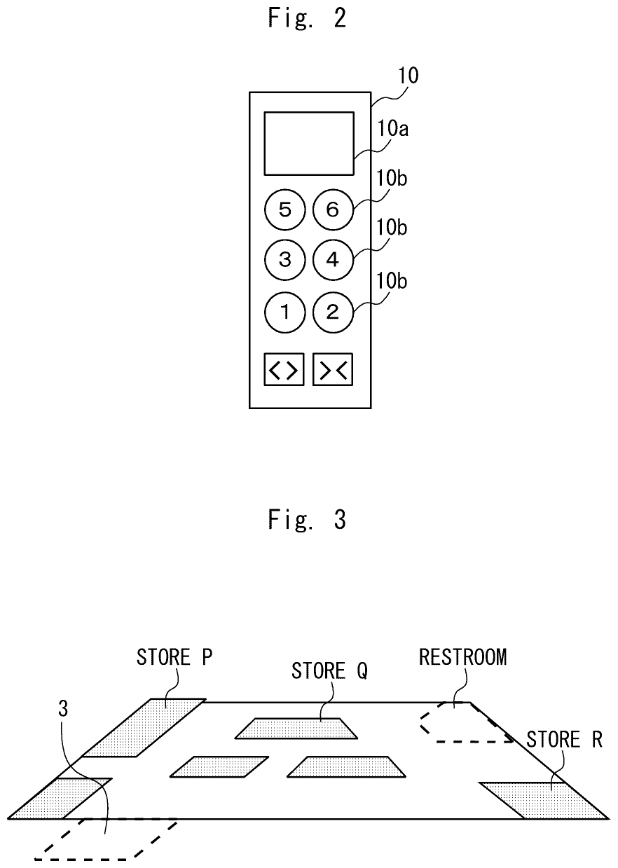

FIG. 2 is a view illustrating an example of the car operating panel 10 according to Embodiment 1.

The car operating panel 10 includes a display panel 10a and a plurality of destination buttons 10b. The display panel 10a is display equipment that displays information to the user who is inside the car 7. The display panel 10a displays, for example, a traveling direction and a current floor of the car 7. Each destination button 10b corresponds to one of the floors. Each destination button 10b is a button that accepts operation of designating a corresponding floor as the destination floor. Each destination button 10b includes light emission equipment (not illustrated) that is lighted, for example, when the destination button 10b is operated by the user. In this example, the light emission equipment is equipment for which brightness of light emission, color tone, whether or not the light blinks, blinking speed, and the like, are variable.

FIG. 3 is a view illustrating an example of areas on the floor according to Embodiment 1.

FIG. 3 illustrates a floor map of one of the floors.

The floor illustrated in FIG. 3 includes a plurality of areas each of which is a store. One of the areas is a store P which deals with an article P1 and an article P2. One of the areas is a store Q which deals with an article Q1 and an article Q2. One of the areas is a store R which provides a service R1 and a service R2.

In this event, the attribute storage unit 13 stores, for example, name of the store “store P” and name of articles “P1” and “P2”, and the like, as an attribute of the area of the store P. In a case where the article P1 and the article P2 are groceries, and the store P is a grocery store, the attribute storage unit 13 may store, for example, a type of the store “grocery store” and a type of articles “groceries” as the attribute of the area.

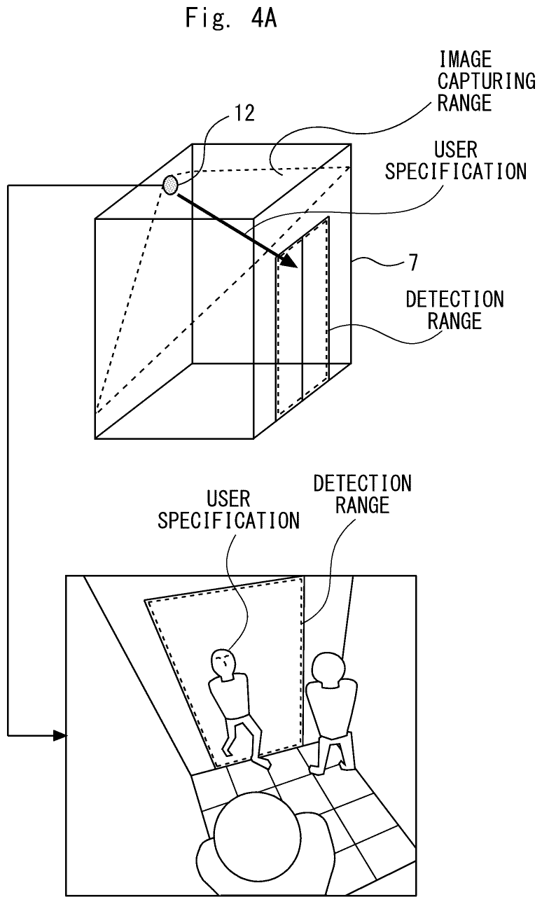

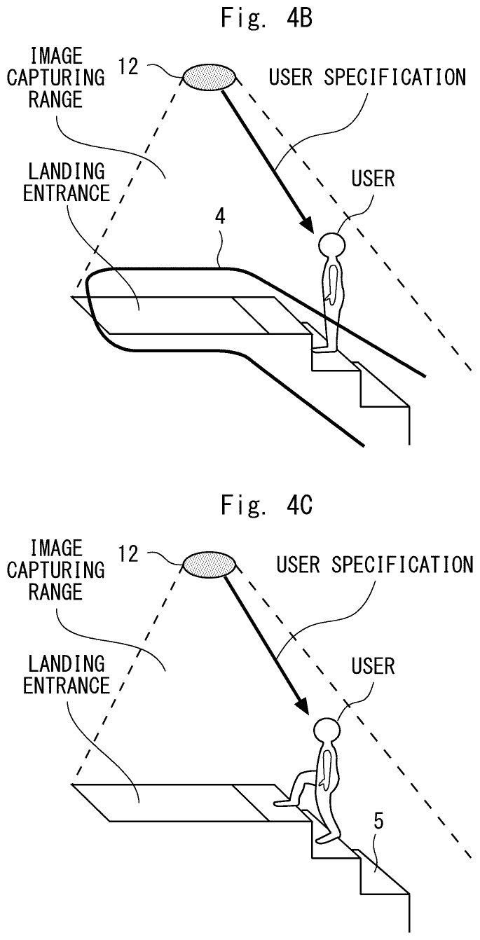

FIG. 4A to FIG. 4C are views illustrating an example of layout of the cameras 12 according to Embodiment 1.

As illustrated in FIG. 4A, one of the cameras 12 is provided inside the car 7 of the elevator 3. The camera 12 is attached to, for example, an upper portion of a wall, a ceiling, or the like. The camera 12 is provided, for example, at a position at which the camera 12 can capture an image of the face of a user who gets on the car 7. Further, one of the cameras 12 is provided at the hall of the elevator 3. The camera 12 is attached to, for example, an upper portion of a wall, a ceiling, or the like.

As illustrated in FIG. 4B, one of the cameras 12 is provided at the landing entrance of the escalator 4. Alternatively, one of the cameras 12 may be provided on a wall surface of an inclined portion before the landing entrance of the escalator 4. The camera 12 is attached to, for example, an upper portion of a wall, a ceiling, or the like. The camera 12 may be attached to a pole, or the like, provided at the landing entrance.

As illustrated in FIG. 4C, one of the cameras 12 is provided at the landing entrance of the stairs 5. Alternatively, one of the cameras 12 may be provided on a wall surface of an inclined portion before the landing entrance of the stairs 5. The camera 12 is attached to, for example, an upper portion of a wall, a ceiling, or the like. The camera 12 may be attached to a pole, or the like, provided at the landing entrance.

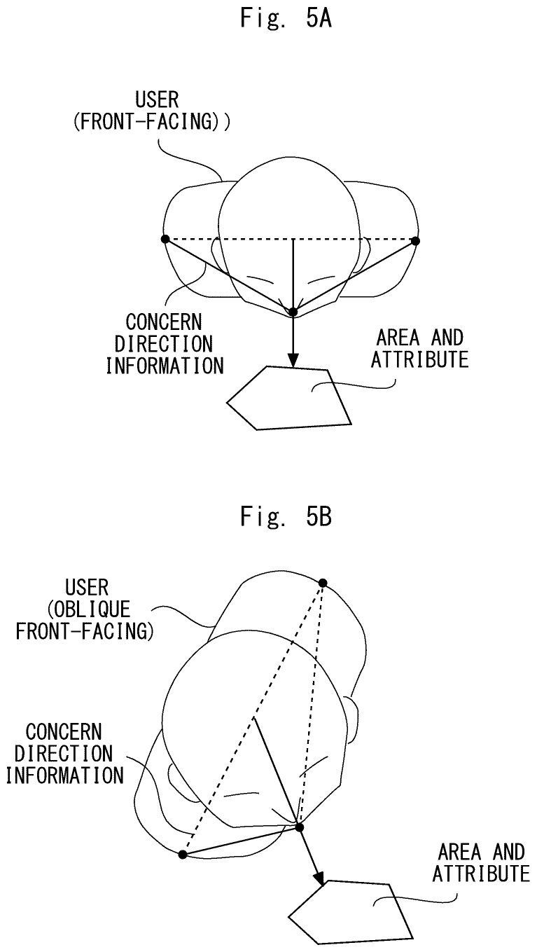

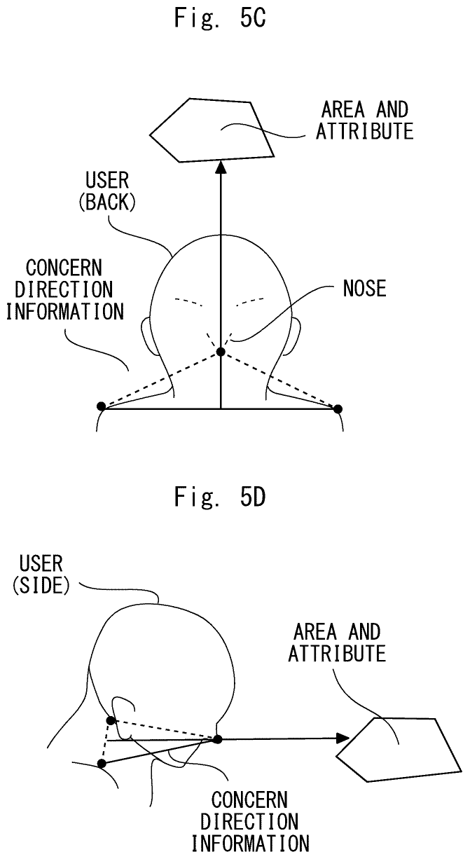

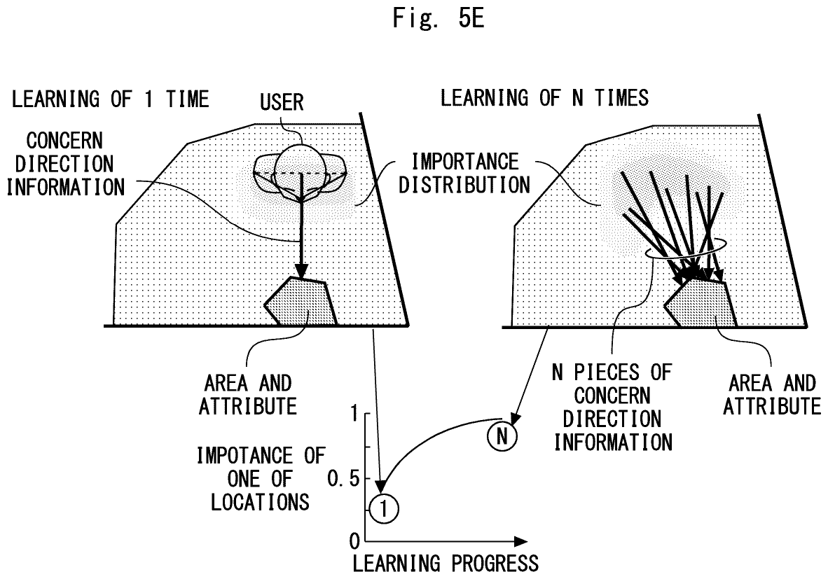

Subsequently, an example of the behavior information will be described using FIG. 5.

FIG. 5A to FIG. 5E are views illustrating an example of the behavior information acquired by the behavior information acquisition unit 15 according to Embodiment 1.

The behavior information acquisition unit 15, for example, extracts feature amounts of the user from the image used by the user specification unit 14 to specify the user. The behavior information acquisition unit 15 may utilize the feature amounts extracted by the user specification unit 14. The feature amounts of the user include, for example, information on positions of feature points such as the nose, ears, eyes, mouth, cheek, jaw and neck of the face and both shoulders. The behavior information acquisition unit 15 acquires the behavior information of the user on the basis of the extracted feature amounts. In this example, the behavior information acquisition unit 15 acquires information including concern direction information as information of layout of the user included in the behavior information of the user. Here, the behavior information acquisition unit 15 continuously acquires the behavior information of the user by tracking the user specified by the user specification unit 14. The behavior information acquisition unit 15 may track the position of the specified user using, for example, a method such as dynamic body tracking. The behavior information acquisition unit 15 may continuously acquire the behavior information of the user who is no longer in the image as a result of moving, by tracking the user.

The concern direction information is an example of information on a direction indicating interest of the user. The concern direction information is information represented using at least three feature amounts of both shoulders and the nose of the user. The concern direction information may be represented using other feature amounts as necessary. In the concern direction information, the concern direction of the user is represented as a direction from a midpoint of a line segment connecting positions of both shoulders toward a position of the nose. Here, it is only necessary to capture feature amounts of the nose as the feature amounts to be used as the concern direction information regardless of whether or not the nose of the user is covered with a mask, or the like, that is, whether or not the naked nose itself of the user is in the image. Further, it is only necessary to capture feature amounts of the shoulders as the feature amounts to be used as the concern direction information regardless of whether or not the shoulders are covered with cloths, or the like, that is, the naked shoulders themselves of the user are in the image. In a similar manner, it is only necessary to capture other feature amounts of organs such as the ears, eyes, mouth, cheek, jaw and neck regardless of whether or not the naked organs themselves of the user are in the image. Further, the concern direction information may be represented using, for example, feature amounts of both shoulders and nose obtained using skeleton information of the user. Still further, the concern direction information may be represented using other feature amounts obtained using the skeleton information.

FIG. 5A illustrates an example of the user seen from above. In this manner, the direction indicating interest of the user is represented using the concern direction information acquired on the basis of the image of the user. FIG. 5B illustrates an example of the image in a case where a direction of the face does not match a direction of the body. In this manner, the direction indicating interest of the user is an extension in a direction from a midpoint of a line segment connecting positions of both shoulders of the user toward the nose. FIG. 5C illustrates an example of the image of the user seen from behind. In a case where the nose of the user is not in the image, the behavior information acquisition unit 15 may complement the nose by complementing the image from the acquired image information. Alternatively, the behavior information acquisition unit 15 may estimate the position of the nose on the basis of other feature points, and the like. Alternatively, the behavior information acquisition unit 15 may specify the position of the nose by synthesizing images captured by the plurality of cameras 12. The behavior information acquisition unit 15 specifies the position of the nose using one of these plurality of methods or a combination of these plurality of methods. In this manner, the direction indicating the interest of the user is represented as an extension of the direction from the midpoint of the line segment connecting the positions of both shoulders toward the position of the nose. FIG. 5D illustrates an example of the image of the user seen from side. In a case where one of the shoulders of the user is not in the image, the behavior information acquisition unit 15 may complement the other shoulder by complementing the image from the acquired image information. Alternatively, the behavior information acquisition unit 15 may estimate the position of the shoulder that is not in the image on the basis of other feature points, and the like. Alternatively, the behavior information acquisition unit 15 may specify positions of both shoulders by synthesizing images captured by the plurality of cameras 12. The behavior information acquisition unit 15 specifies the positions of both shoulders using one of these plurality of methods or a combination of these plurality of methods. In this manner, the direction indicating interest of the user is represented as an extension in a direction from the midpoint of the line segment connecting the positions of both shoulders toward the position of the nose.

As illustrated in FIG. 5E, information on the direction indicating interest of the user may be extracted through, for example, image processing or the like by AI installed on the behavior information acquisition unit 15. The image processing by the AI is, for example, processing, or the like, using a machine learning method that uses an image as an input. A model that derives behavior information from the image of the user is learned using the machine learning method. The behavior information acquisition unit 15 acquires behavior information from the image of the user on the basis of the learned model. The behavior information acquisition unit 15 may, for example, perform supervised learning using a set of the image of the user and concern direction information obtained from the image as training data. Here, the concern direction information obtained from the image is, for example, concern direction information obtained from the positions of both shoulders and the nose. In this event, the behavior information acquisition unit 15 receives an input of the image of the user and outputs the concern direction information on the basis of the result of learning. The behavior information acquisition unit 15 may extract feature amounts of the image through deep learning. In FIG. 5E, an example of degrees of importance of the feature amounts of the image are indicated using color density. Alternatively, the behavior information acquisition unit 15 may extract information on the direction indicating interest of the user from the image using other machine learning methods such as unsupervised learning and reinforcement learning.

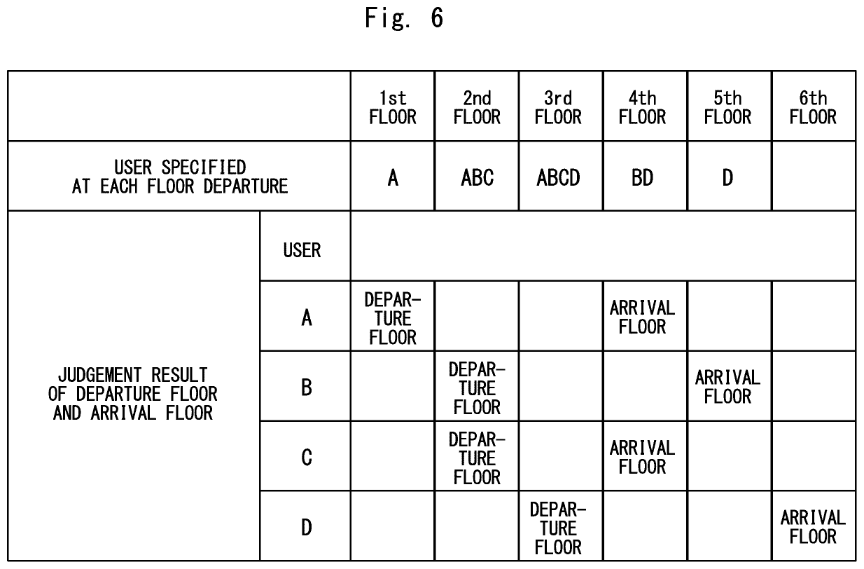

Subsequently, an example of judgement of the arrival floor will be described using FIG. 6.

FIG. 6 is a table indicating an example of judgement by the floor judgement unit 19 according to Embodiment 1.

FIG. 6 indicates an example of judgement of the arrival floor of the user who utilizes the elevator 3 that performs upward operation from the first floor. In this example, the elevator 3 performs descending operation to the first floor and then starts upward operation from the first floor. Note that the arrival floor is judged in a similar manner also in a case where the elevator 3 performs upward operation from other floors and in a case where the elevator 3 performs descending operation.

A user A who moves from the first floor to the fourth floor registers call in the elevator 3 through operation of the hall operating panel 9 on the first floor. Then, the user A gets on the car 7 of the elevator 3 that arrives on the first floor. The user A who gets on the car 7 designates the fourth floor as the destination floor through operation of the car operating panel 10.

When the car 7 of the elevator 3 departs from the first floor, the user specification unit 14 specifies the user who is inside the car 7 on the basis of the image captured by the camera 12 inside the car 7. In this example, only the user A is in the car 7. In this event, the user specification unit 14 specifies the user A as the user who is inside the car 7. The ascending/descending facility judgement unit 17 judges that the ascending/descending facility to be utilized by the user A is the elevator 3. The floor judgement unit 19 judges the departure floor and the arrival floor of the user by comparing users who are in the car 7 when the car 7 departs from the floor on which the car 7 stops at the last minute and users who are in the car 7 when the car 7 departs from the first floor. In this event, the floor on which the car 7 stops at the last minute is one of the floors, which is higher than the first floor and on which the car 7 stops during descending operation. The floor judgement unit 19 judges the departure floor of the user A who is not in the car 7 when the car 7 departs from the floor on which the car 7 stops at the last minute and who is in the car 7 when the car 7 departs from the first floor, as the first floor.

When the ascending/descending facility judgement unit 17 judges the ascending/descending facility to be utilized by the user A, the matching processing unit 18 performs matching processing to achieve matching for the user A. For example, in a case where the ascending/descending facility judgement unit 17 judges that the user A has already redundantly utilized other ascending/descending facilities at the same time point, the matching processing unit 18 causes the user specification unit 14 to specify a plurality of users erroneously specified as the same user as different users. When the user specification unit 14 specifies the users as users different from each other, the user specification unit 14 extracts a difference in feature amounts of the users from the acquired images, improves accuracy of specification of the users and resettles specification of the users different from each other. The matching processing unit 18 performs matching processing on other users in a similar manner.

A user B who moves from the second floor to the fifth floor registers call in the elevator 3 through operation of the hall operating panel 9 on the second floor. Then, the user B gets on the car 7 of the elevator 3 that arrives on the second floor. The user B who gets on the car 7 designates the fifth floor as the destination floor through operation of the car operating panel 10. A user C who moves from the second floor to the fourth floor arrives at the hall on the second floor of the elevator 3. The call has already been registered from the hall operating panel 9 on the second floor by the user B, and thus, the user C who arrives at the hall does not perform operation of registering the destination floor on the hall operating panel 9. Further, the user C does not have to have a mobile terminal such as a smartphone, a card and a tag that accepts operation of registering the destination floor. Then, the user C gets on the car 7 of the elevator 3 that arrives on the second floor. The fourth floor has already been designated as the destination floor by the user A, the user C who gets on the car 7 does not perform operation of registering the destination floor on the car operating panel 10.

When the car 7 of the elevator 3 departs from the second floor, the user specification unit 14 specifies users who are inside the car 7 on the basis of the image captured by the camera 12 inside the car 7. In this example, the user A, the user B and the user C are in the car 7. In this event, the user specification unit 14 specifies the user A, the user B and the user C as users who are inside the car 7. The ascending/descending facility judgement unit 17 judges that the ascending/descending facility to be utilized by the user B is the elevator 3. The floor judgement unit 19 judges the departure floor and the arrival floor of the user by comparing users who are inside the car 7 when the car 7 departs from the first floor that is a floor on which the car 7 stops at the last minute and users who are inside the car 7 when the car 7 departs from the second floor. The floor judgement unit 19 judges the departure floor of the user B and the user C who are not in the car 7 when the car 7 departs from the first floor and who are in the car 7 when the car 7 departs from the second floor, as the second floor.

A user D who moves from the third floor to the sixth floor registers call in the elevator 3 through operation on the hall operating panel 9 on the third floor. Then, the user A gets on the car 7 of the elevator 3 that arrives on the third floor. The user D who gets on the car 7 designates the sixth floor as the destination floor through operation on the car operating panel 10.

When the car 7 of the elevator 3 departs from the third floor, the user specification unit 14 specifies users who are inside the car 7 on the basis of the image captured by the camera 12 inside the car 7. In this example, the user A, the user B, the user C and the user D are in the car 7. In this event, the user specification unit 14 specifies the user A, the user B, the user C and the user D as the users who are inside the car 7. The ascending/descending facility judgement unit 17 judges that the ascending/descending facility to be utilized by the user D is the elevator 3. The floor judgement unit 19 judges the departure floor and the arrival floor of the user by comparing users who are inside the car 7 when the car 7 departs from the second floor that is the floor on which the car 7 stops at the last minute and users who are inside the car 7 when the car 7 departs from the third floor. The floor judgement unit 19 judges the departure floor of the user D who is not in the car 7 when the car 7 departs from the second floor and who is in the car 7 when the car 7 departs from the third floor, as the third floor.

The user A and the user C get off the car 7 of the elevator 3 on the fourth floor.

When the car 7 of the elevator 3 departs from the fourth floor, the user specification unit 14 specifies users who are inside the car 7 on the basis of the image captured by the camera 12 inside the car 7. In this example, the user B and the user D are in the car 7. In this event, the user specification unit 14 specifies the user B and the user D as the users who are inside the car 7. The floor judgement unit 19 judges the departure floor and the arrival floor of the user by comparing users who are inside the car 7 when the car 7 departs from the third floor that is a floor on which the car 7 stops at the last minute and users who are inside the car 7 when the car 7 departs from the fourth floor. The floor judgement unit 19 judges the arrival floor of the user A and the user C who are in the car 7 when the car 7 departs from the third floor and who are not in the car 7 when the car 7 departs from the fourth floor, as the fourth floor. In this manner, also for the user C who does not perform operation of registering the destination floor on the hall operating panel 9 and the car operating panel 10, and a mobile terminal such as a smartphone, a card and a tag, the guidance system 1 can acquire information on the departure floor and the arrival floor on the basis of the image captured by the camera 12 inside the car 7.

The user B gets off the car 7 of the elevator 3 on the fifth floor.

When the car 7 of the elevator 3 departs from the fifth floor, the user specification unit 14 specifies users who are inside the car 7 on the basis of the image captured by the camera 12 inside the car 7. In this example, only the user D is in the car 7. In this event, the user specification unit 14 specifies only the user D as the user who is inside the car 7. The floor judgement unit 19 judges the departure floor and the arrival floor of the user by comparing users who are inside the car 7 when the car 7 departs from the fourth floor on which the car 7 stops at the last minute and users who are inside the car 7 when the car 7 departs from the fifth floor. The floor judgement unit 19 judges the arrival floor of the user B who is in the car 7 when the car 7 departs from the fourth floor and who is not in the car 7 when the car 7 departs from the fifth floor, as the fifth floor.

The user D gets off the car 7 of the elevator 3 on the sixth floor.

When the car 7 of the elevator 3 departs from the sixth floor, the user specification unit 14 specifies users who are inside the car 7 on the basis of the image captured by the camera 12 inside the car 7. In this example, there is no user in the car 7. In this event, the user specification unit 14 specifies no user as the users who are inside the car 7. The floor judgement unit 19 specifies the departure floor and the arrival floor of the user by comparing users who are inside the car 7 when the car 7 departs from the fifth floor which is a floor on which the car 7 stops at the last minute and users who are inside the car 7 when the car 7 departs from the sixth floor. The floor judgement unit 19 judges the arrival floor of the user D who is in the car 7 when the car 7 departs from the fifth floor and who is not in the car 7 when the car 7 departs from the sixth floor, as the sixth floor.

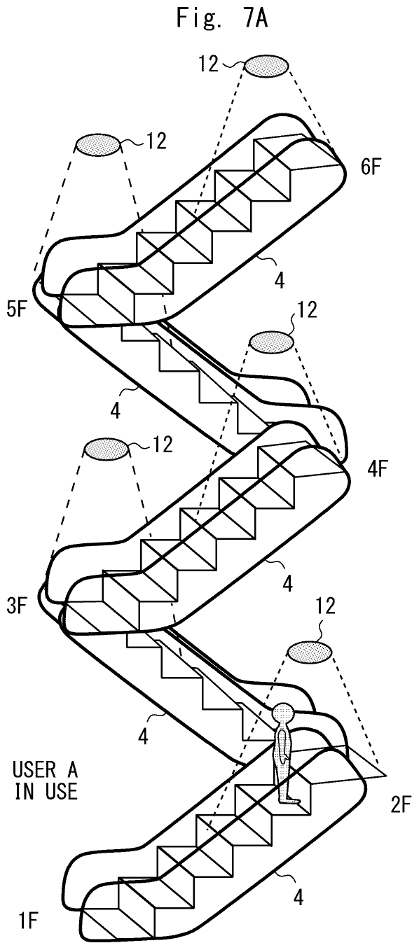

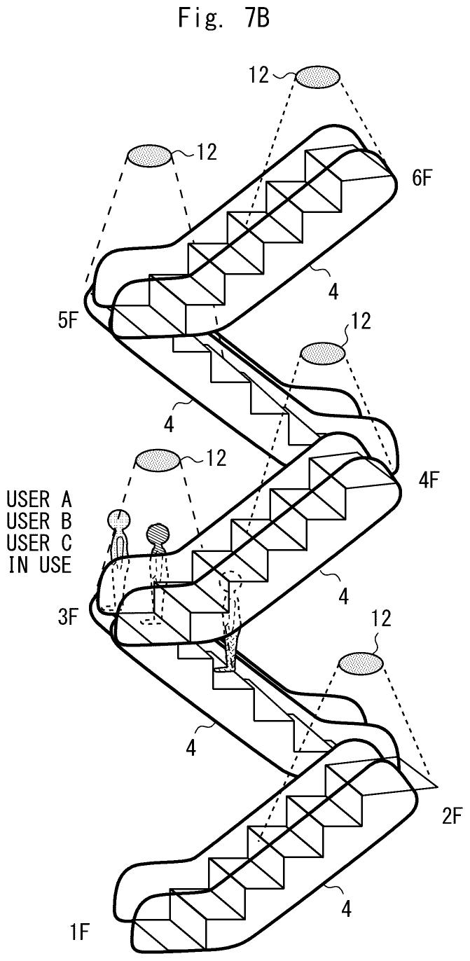

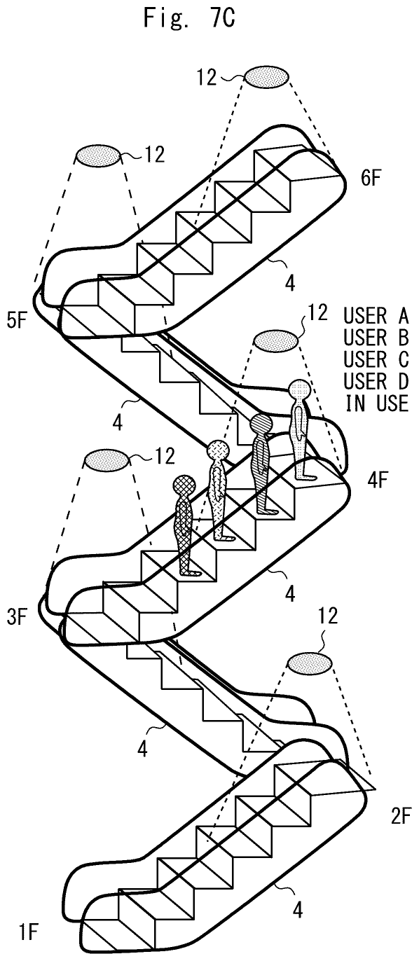

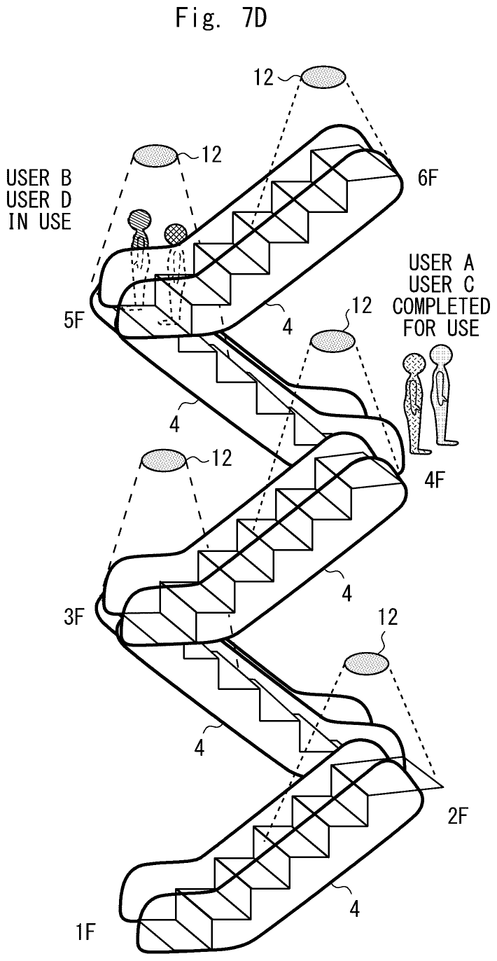

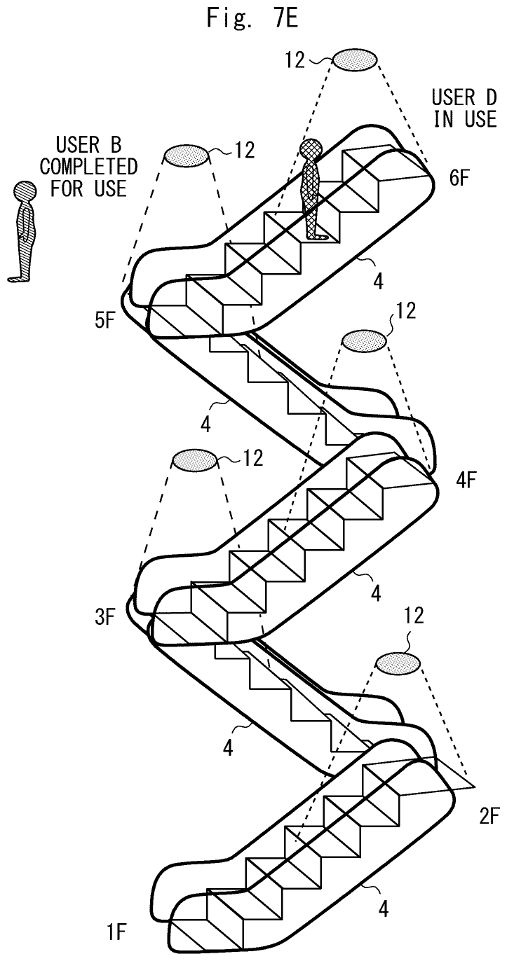

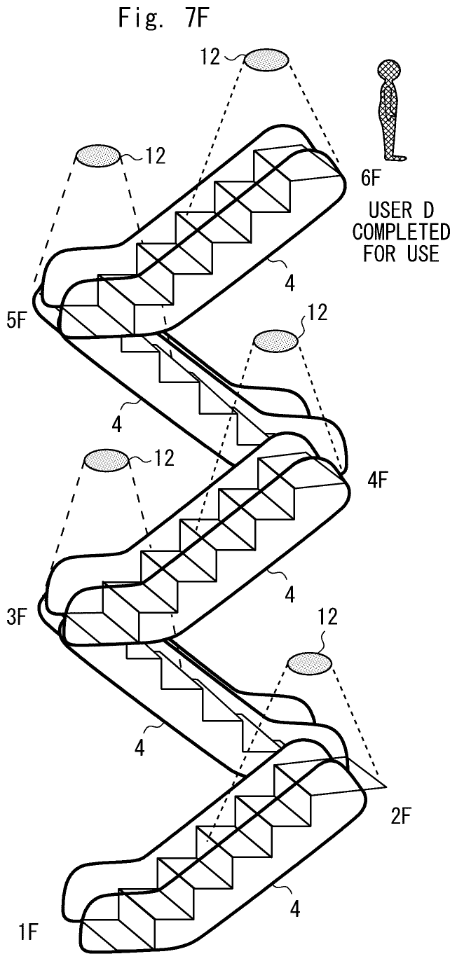

Subsequently, another example of judgement of the arrival floor will be described using FIG. 7.

FIG. 7A to FIG. 7F are views illustrating an example of judgement by the floor judgement unit 19 according to Embodiment 1.

FIG. 7 illustrate an example of judgement of the arrival floor of the user who transfers and utilizes a plurality of escalators 4 that perform upward operation. Note that also in a case where one escalator 4 that performs upward operation is utilized, and in a case where one or more escalators 4 that perform descending operation are utilized, the arrival floor is judged in a similar manner. Further, also in a case where the stairs 5 are utilized, the arrival floor is judged in a similar manner.

As illustrated in FIG. 7A, the user A who moves from the first floor to the fourth floor moves by getting on the escalator 4 that performs upward operation between the first floor and the second floor, from the first floor.

When the user A who is on the escalator 4 falls within an image capturing range of the camera 12 provided at the exit on the second floor, that is, when the user A comes into a frame of the camera 12, the user specification unit 14 specifies the user A on the basis of the image captured by the camera 12. The ascending/descending facility judgement unit 17 judges that the ascending/descending facility utilized by the user A is the escalator 4. The floor judgement unit 19 judges that the departure floor of the user A is the first floor on which the entrance of the escalator 4 is provided.

As illustrated in FIG. 7B, the user A moves while transferring the escalator 4 to the escalator 4 that performs upward operation between the second floor and the third floor, on the second floor. The user B who moves from the second floor to the fifth floor moves by getting on the escalator 4 that performs upward operation between the second floor and the third floor, from the second floor. The user C who moves from the second floor to the fourth floor moves by getting on the escalator 4 that performs upward operation between the second floor and the third floor, from the second floor.

When the user A comes into a frame of the camera 12 provided at the exit on the third floor, the user specification unit 14 specifies the user A on the basis of the image captured by the camera 12. When the user A is specified by the camera 12 provided at the exit on the third floor before a preset period has elapsed since the user A had been specified by the camera 12 provided at the exit on the second floor, the floor judgement unit 19 judges that the user A has transferred the escalator 4 on the second floor.

When the user B comes into a frame of the camera 12 provided at the exit on the third floor, the user specification unit 14 specifies the user B on the basis of the image captured by the camera 12. The ascending/descending facility judgement unit 17 judges that the ascending/descending facility utilized by the user B is the escalator 4. The floor judgement unit 19 judges that the departure floor of the user B is the second floor on which the entrance of the escalator 4 is provided.

When the user C comes into a frame of the camera 12 provided at the exit on the third floor, the user specification unit 14 specifies the user C on the basis of the image captured by the camera 12. The ascending/descending facility judgement unit 17 judges that the ascending/descending facility utilized by the user C is the escalator 4. The floor judgement unit 19 judges that the departure floor of the user C is the second floor on which the entrance of the escalator 4 is provided.

As illustrated in FIG. 7C, the user A moves while transferring the escalator 4 to the escalator 4 that performs upward operation between the third floor and the fourth floor, on the third floor. The user B moves while transferring the escalator 4 to the escalator 4 that performs upward operation between the third floor and the fourth floor, on the third floor. The user C moves while transferring the escalator 4 to the escalator 4 that performs upward operation between the third floor and the fourth floor, on the third floor. The user D who moves from the third floor to the sixth floor moves by getting on the escalator 4 that performs upward operation between the third floor and the fourth floor, from the third floor.

When the user A comes into a frame of the camera 12 provided at the exit on the fourth floor, the user specification unit 14 specifies the user A on the basis of the image captured by the camera 12. When the user A is specified by the camera 12 provided at the exit on the fourth floor before a preset period has elapsed since the user A had been specified by the camera 12 provided at the exit on the third floor, the floor judgement unit 19 judges that the user A has transferred the escalator 4 on the third floor.

When the user B comes into a frame of the camera 12 provided at the exit on the fourth floor, the user specification unit 14 specifies the user B on the basis of the image captured by the camera 12. When the user B is specified by the camera 12 provided at the exit on the fourth floor before a preset period has elapsed since the user B had been specified by the camera 12 provided at the exit on the third floor, the floor judgement unit 19 judges that the user B has transferred the escalator 4 on the third floor.

When the user C comes into a frame of the camera 12 provided at the exit on the fourth floor, the user specification unit 14 specifies the user C on the basis of the image captured by the camera 12. When the user C is specified by the camera 12 provided at the exit on the fourth floor before a preset period has elapsed since the user C had been specified by the camera 12 provided at the exit on the third floor, the floor judgement unit 19 judges that the user C has transferred the escalator 4 on the third floor.

When the user D comes into a frame of the camera 12 provided at the exit on the fourth floor, the user specification unit 14 specifies the user D on the basis of the image captured by the camera 12. The ascending/descending facility judgement unit 17 judges that the ascending/descending facility utilized by the user D is the escalator 4. The floor judgement unit 19 judges that the departure floor of the user D is the third floor on which the entrance of the escalator 4 is provided.

As illustrated in FIG. 7D, the user A gets off the escalator 4 from the exit on the fourth floor. The user B moves while transferring the escalator 4 to the escalator 4 that performs upward operation between the fourth floor and the fifth floor, on the fourth floor. The user C gets off the escalator 4 from the exit on the fourth floor. The user D moves while transferring the escalator 4 to the escalator 4 that performs upward operation between the fourth floor and the fifth floor, on the fourth floor.

When the user A is not specified by the camera 12 provided at the exit on the fifth floor even after the preset period has elapsed since the user A had been specified by the camera 12 provided at the exit on the fourth floor, the floor judgement unit 19 judges that the arrival floor of the user A is the fourth floor.

When the user B comes into a frame of the camera 12 provided at the exit on the fifth floor, the user specification unit 14 specifies the user B on the basis of the image captured by the camera 12. When the user B is specified by the camera 12 provided at the exit on the fifth floor before a preset period has elapsed since the user B had been specified by the camera 12 provided at the exit on the fourth floor, the floor judgement unit 19 judges that the user A has transferred the escalator 4 on the fourth floor.

When the user C is not specified by the camera 12 provided at the exit on the fifth floor even after the preset period has elapsed since the user C had been specified by the camera 12 provided at the exit on the fourth floor, the floor judgement unit 19 judges that the arrival floor of the user C is the fourth floor.

When the user D comes into a frame of the camera 12 provided at the exit on the fifth floor, the user specification unit 14 specifies the user D on the basis of the image captured by the camera 12. When the user D is specified by the camera 12 provided at the exit on the fifth floor before a preset period has elapsed since the user D had been specified by the camera 12 provided at the exit on the fourth floor, the floor judgement unit 19 judges that the user D has transferred the escalator 4 on the fourth floor.

As illustrated in FIG. 7E, the user B gets off the escalator 4 at the exit on the fifth floor. The user D moves while transferring the escalator 4 to the escalator 4 that performs upward operation between the fifth floor and the sixth floor, on the fifth floor.

When the user B is not specified by the camera 12 provided at the exit on the sixth floor even after the preset period has elapsed since the user B had been specified by the camera 12 provided at the exit on the fifth floor, the floor judgement unit 19 judges that the arrival floor of the user B is the sixth floor.

When the user D comes into a frame of the camera 12 provided at the exit on the sixth floor, the user specification unit 14 specifies the user D on the basis of the image captured by the camera 12. When the user D is specified by the camera 12 provided at the exit on the sixth floor before a preset period has elapsed since the user D had been specified by the camera 12 provided at the exit on the fifth floor, the floor judgement unit 19 judges that the user D has transferred the escalator 4 on the fifth floor.

As illustrated in FIG. 7F, the user D gets off the escalator 4 from the exit on the sixth floor.

When the user D is not specified by the camera 12 provided at the exit of the escalator 4 even after the preset period has elapsed since the user B had been specified by the camera 12 provided at the exit on the sixth floor, the floor judgement unit 19 judges that the arrival floor of the user B is the sixth floor.

Note that the users get on and get off the escalator 4 at timings for each user, and thus, the floor judgement unit 19 manages information on states where the users get on and get off the escalator 4 for each user.

Further, while an example of judgement of the arrival floor of the user of the escalator 4 has been described using FIGS. 7, the arrival floor of the user of the stairs 5 is judged in a similar manner. The stairs 5 are different from the escalator 4 in that while the user of the escalator 4 can move between the floors without walking, the user of the stairs 5 moves between the floors by walking. For the user of the escalator 4 and the user of the stairs 5, specification of the user by the user specification unit 14, exclusion processing of the user by the matching processing unit 18, judgement of a utilization start floor and a utilization end floor of the ascending/descending facility by the camera 12, and the like, are similarly performed through similar processing flow.

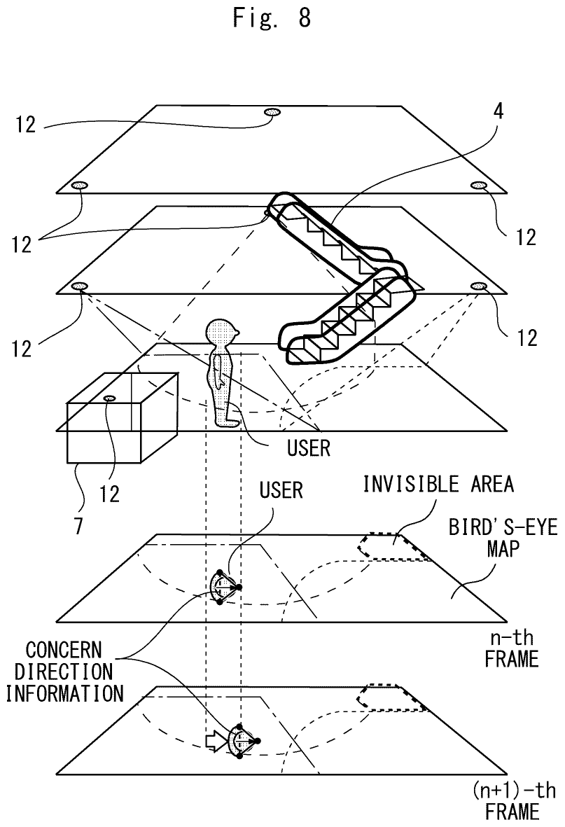

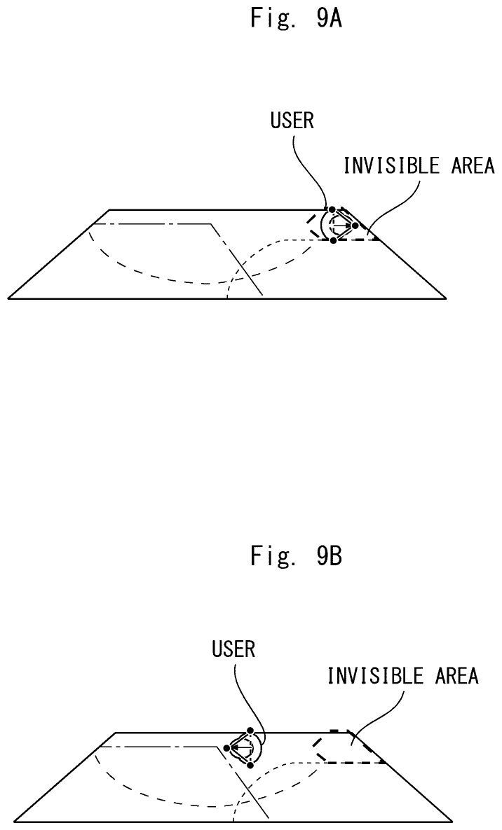

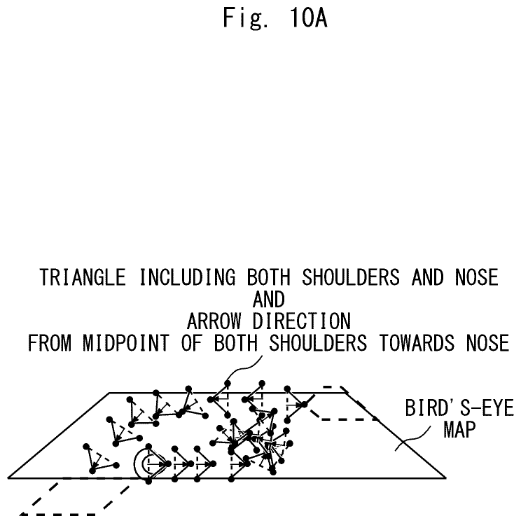

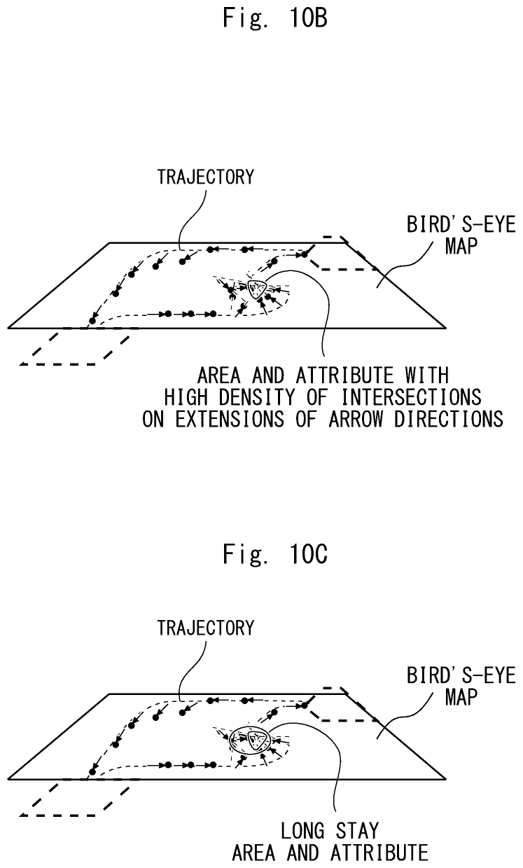

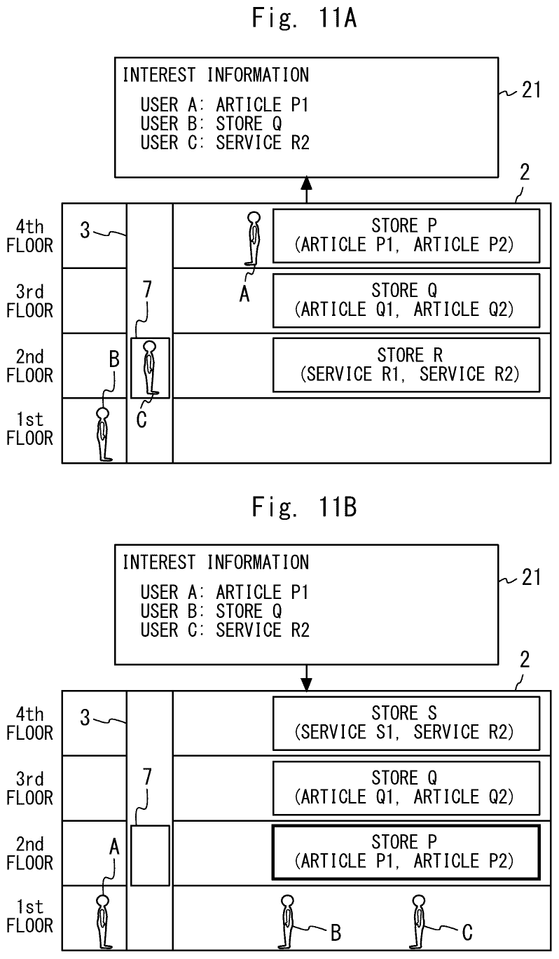

Subsequently, an example of acquisition of the behavior information on the arrival floor will be described using FIG. 8 and FIG. 9. Further, an example of acquisition of interest information on the arrival floor will be described using FIG. 10.

FIG. 8, FIG. 9A and FIG. 9B are views illustrating an example of acquisition of the behavior information by the guidance system 1 according to Embodiment 1.

FIG. 10A to FIG. 10C are views illustrating an example of acquisition of the interest information by the guidance system 1 according to Embodiment 1.

Bird's-eye maps of the arrival floors illustrated in FIG. 8, FIG. 9 and FIG. 10 are, for example, generated on the basis of images captured by a plurality of cameras 12 provided on the arrival floors. The bird's-eye maps are, for example, images obtained by pasting on a plane, a plurality of images of the arrival floors captured at the same time point and synthesizing the images while avoiding inconsistency at peripheral portions of the overlapped images. In this event, the bird's-eye map may include an invisible area. The invisible area is an area for which no camera 12 can capture an image. The invisible area may be, for example, inside a hoistway after the car 7 of the elevator 3 moves from the arrival floor, a restroom provided on the arrival floor, a range for which it is known that the user does not utilize, or the like. The bird's-eye map is generated in advance on the basis of the images acquired during a period while there is no user, such as, for example, night-time and early morning. The bird's-eye map may be updated, for example, once a day or may be updated as appropriate. While the images to be used for generation of the bird's-eye map are preferably captured at the same time point by the plurality of cameras 12 on the arrival floors because there is a possibility that users are in the images, the bird's-eye map does not necessarily have to be generated from the images all at the same time point. The bird's-eye map may be generated from a plurality of images which do not include users and which are captured at different time points.

FIG. 8 illustrates an example of the user who arrives on the arrival floor by utilizing the elevator 3.

The behavior information acquisition unit 15 starts acquisition of the behavior information, for example, when the user arrives on the arrival floor. For example, when the floor judgement unit 19 judges the arrival floor of one of the users, the behavior information acquisition unit 15 judges that the user has arrived on the arrival floor. When the user arrives on the arrival floor, the behavior information acquisition unit 15 acquires the bird's-eye map of the arrival floor.

In this example, the behavior information acquisition unit 15 lays out information that is represented using at least three feature amounts of both shoulders and the nose of the user acquired on the basis of the images on the bird's-eye map. As a result of this, a coordinate of the user on the arrival floor, on the bird's-eye map is acquired. The behavior information acquisition unit 15 adds the information acquired in this manner to the behavior information which is time-series data as information representing layout of the user.

Then, after a preset time interval has elapsed, the behavior information acquisition unit 15 newly acquires information representing layout of the user. The behavior information acquisition unit 15 adds the newly acquired information to the behavior information which is time-series data. In this manner, the behavior information acquisition unit 15 continuously updates the behavior information of the user.

As illustrated in FIG. 9A, when the user goes out of a frame to an invisible area such as a restroom, the behavior information acquisition unit 15 starts counting of an elapsed period since the user has gone out of the frame. During this period, the behavior information acquisition unit 15 pauses acquisition of the behavior information of the user. Thereafter, as illustrated in FIG. 9B, when the user comes into the frame from the invisible area before a preset period has elapsed since the user had gone out of the frame, the behavior information acquisition unit 15 continues to acquire the behavior information of the user.

When the user moves from the arrival floor to other floors, the behavior information acquisition unit 15 specifies movement of the user in coordination with the camera 12 inside the car 7 of the elevator 3, the camera 12 of the escalator 4, the camera 12 of the stairs 5 and a plurality of cameras 12 on the other floors. In a case where the preset period has elapsed since the user had gone out of the frame during movement on a certain floor and coordination of the plurality of cameras 12 is released, the behavior information acquisition unit 15 records, for example, a time point and a location at which the user has gone out of the frame last. In this event, the behavior information acquisition unit 15 may display the location on the bird's-eye map and call for attention using a warning, and the like, as necessary.

The behavior information storage unit 16 stores the behavior information acquired by the behavior information acquisition unit 15 for each user. The behavior information storage unit 16 accumulates and stores a plurality of pieces of behavior information for the same user.

The interest information acquisition unit 20 acquires interest information of the user every time the behavior information acquisition unit 15 completes acquisition of the behavior information of the user on the arrival floor.

As illustrated in FIG. 10A, the interest information acquisition unit 20 superimposes the information representing layout of the user included in the behavior information on the arrival floor, on the bird's-eye map of the arrival floor. In this example, the interest information acquisition unit 20 superimposes a triangle including three points of coordinates of three feature amounts of at least both shoulders and the nose and a direction from a midpoint of a line segment connecting the two points of both shoulders toward the nose, included in the behavior information which is time-series data, on the bird's-eye map of the arrival floor.

As illustrated in FIG. 10B, the interest information acquisition unit 20 specifies and acquires an area and an attribute located on an extension in a direction from the midpoint of the line segment connecting the two points of both shoulders toward the nose, included in the behavior information which is time-series data. The interest information acquisition unit 20 extends the direction of the user represented in each piece of concern direction information, ahead of the user. The interest information acquisition unit 20 detects intersections of a plurality of half lines extending ahead of the user. The interest information acquisition unit 20 specifies an area and an attribute in which intersections are concentrated as a range for which a degree of interest of the user is high. In this event, the interest information acquisition unit 20 may, for example, include information on the degree of interest of the user into the interest information of the user in accordance with density of the intersections. The interest information acquisition unit 20 reads the attribute of the area specified as the range for which the degree of interest of the user is high from the attribute storage unit 13. The interest information acquisition unit 20 includes the read attribute in the interest information as an attribute for which the degree of interest of the user is high. In this event, the interest information acquisition unit 20 acquires the read attribute and information on the degree of interest of the user in association with each other.

As illustrated in FIG. 10C, the interest information acquisition unit 20 generates a trajectory of the user by connecting the concern direction information on the bird's-eye map. The interest information acquisition unit superimposes a time point at which the user is located at the position on each point on the trajectory of the user on the bird's-eye map. There is a case where a location where points of the time points are concentrated can be found by tracking the trajectory generated in this manner. Such a location corresponds to a location where the user stays for a long period. The interest information acquisition unit 20 may include the location where the user stays for a long period as an element of the interest information of the user.

The interest information storage unit 21 stores the interest information acquired by the interest information acquisition unit 20 for each user. The interest information storage unit 21 may update the stored interest information in a case where the interest information acquisition unit 20 acquires interest information of the user for whom the interest information has already been stored. For example, the interest information storage unit 21 may add information on the degree of interest for each attribute calculated by the interest information acquisition unit 20 to the stored information on the level of interest for each attribute. As a result of the interest information of each user being sequentially updated, accuracy of the interest information stored in the interest information storage unit 21 is further improved.

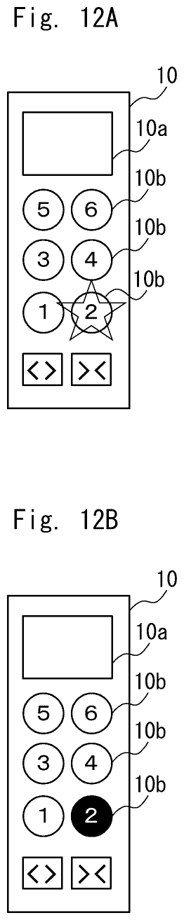

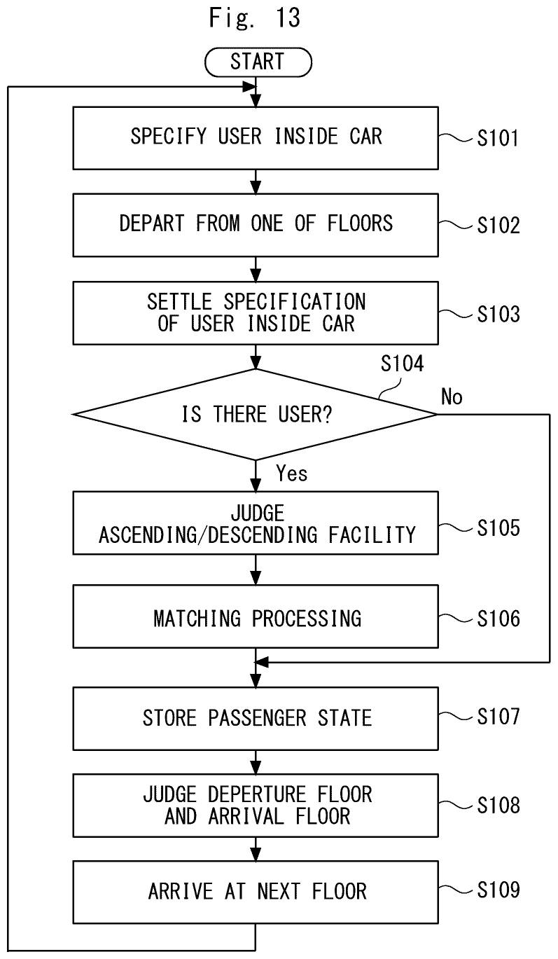

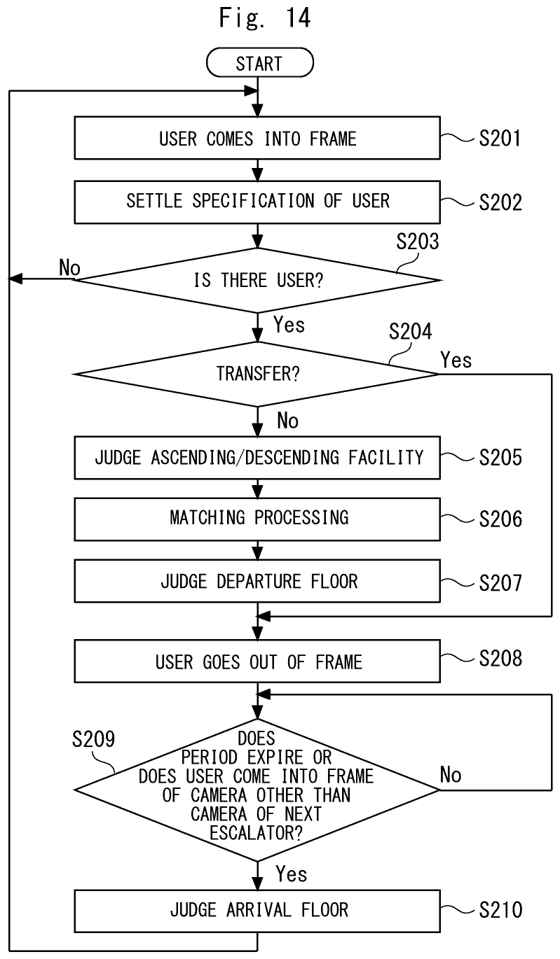

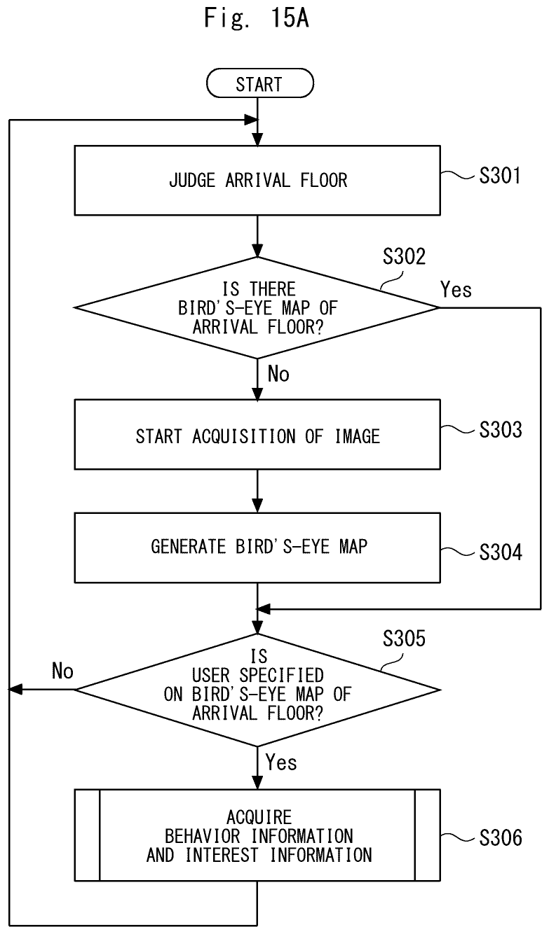

Subsequently, an example of presentation of the destination to the user will be described using FIG. 11 and FIG. 12.

FIG. 11A, FIG. 11B, FIG. 12A and FIG. 12B are views illustrating an example of presentation of the destination by the guidance system 1 according to Embodiment 1.

FIG. 11 illustrate an example of the building 2 to which the guidance system 1 is applied.

FIG. 11A illustrates the building 2 at a certain date. In this building 2, the store P which deals with the article P1 and the article P2 is open in the area on the fourth floor. Further, the store Q which deals with the article Q1 and the article Q2 is open in the area on the third floor. Still further, the store R which provides the service R1 and the service R2 is open in the area on the second floor.

Until this date, the guidance system 1 acquires interest information of the user A, the user B and the user C. The interest information storage unit 21 stores the article P1 as the attribute with the highest degree of interest for the user A. The interest information storage unit 21 stores the store Q as the attribute with the highest degree of interest for the user B. The interest information storage unit 21 stores the service R2 as attribute with the highest degree of interest for the user C.

FIG. 11B illustrates the same building 2 at a later date. By this date, the store P that deals with the article P1 has moved to an area on the second floor. Further, the store R has been closed. Still further, a store S that provides a service S1 and the service R2 has been open in an area on the fourth floor.

The user A who visits the building 2 again at this date is specified by the user specification unit 14 by the images captured by a plurality of cameras 12 provided on the first floor or the camera 12 inside the car 7 of the elevator 3 on which the user gets. In this event, the destination presentation unit 22 reads the interest information for the user A from the interest information storage unit 21. The destination presentation unit 22 in this example presents an area with an attribute with the highest degree of interest to the user as the destination. In other words, the area with the attribute with the highest degree of interest is preferentially presented. Thus, the destination presentation unit 22 acquires the article P1 as the attribute with the highest degree of interest of the user A. The destination presentation unit 22 extracts an area having the article P1 as the attribute from the attribute storage unit 13. In this example, the destination presentation unit 22 extracts the area on the second floor in which the moved store P is open. The destination presentation unit 22 presents the extracted area to the user A as the destination.

Further, the user B who visits the building 2 again at this date is specified by the user specification unit 14 by the images captured by the plurality of cameras 12 provided on the first floor or the camera 12 at the exit of the escalator 4 that captures images after the user gets on the escalator 4 and before the user gets off the escalator 4. In this event, in a similar manner to presentation to the user A, the destination presentation unit 22 presents the area on the third floor in which the store Q is open as the destination on the basis of the interest information. Further, the user C who visits the building 2 again at this date is specified by the user specification unit 14 by the images captured by the plurality of cameras 12 provided on the first floor or the camera 12 of the stairs 5 that captures images after the user starts utilization of the stairs 5 and before the user arrives on the arrival floor. In this event, in a similar manner to presentation to the user A, the destination presentation unit 22 presents the area on the fourth floor in which the store S that provides the service R2 is open as the destination on the basis of the interest information.

Note that the destination presentation unit 22 presents a route to the destination floor including the area of the destination and the area of the destination to the user who utilizes the escalator 4 or the stairs 5 using, for example, a video or a speech. In this event, the destination presentation unit 22 may present the attribute with the highest degree of interest of the user used for extracting the destination of the user together, to the user. The destination presentation unit 22 may, for example, present information such as “the store Q is on a left side of the exit on the third floor” to the user B. Further, the destination presentation unit 22 may, for example, present information such as “the store S that provides the service R2 is in front of the exit on the fourth floor” to the user C. By this means, it is possible to present the destination to the user without using personal information such as name of the user.

FIG. 12 illustrate an example of presentation of the destination using the car operating panel 10. In this example, the second floor is presented to the user A who gets on the car 7 as the destination floor. Note that while FIG. 12 illustrate an example in a case where the car operating panel 10 is utilized, in a case where a mobile terminal such as a smartphone carried by the user can directly or indirectly perform communication with the elevator 3, calling for attention to the user, registration of call, guidance, and the like, may be performed through the mobile terminal in a similar manner to a case where the car operating panel 10 is utilized.

As illustrated in FIG. 12A, the destination presentation unit 22 calls for attention to guidance before the second floor is registered as the destination floor, to the user A by causing light emission equipment of the destination button 10b corresponding to the second floor to blink. In this event, the destination presentation unit 22 may display a video such as “the store P that deals with the article P1 is on the second floor” together on display equipment such as a display panel 10a. Further, the destination presentation unit 22 may cause a built-in speaker of the display equipment such as the display panel 10a to present guidance using a speech together. Here, for example, when a preset period has elapsed since presentation by blinking of the light emission equipment had been started, the call registration unit 23 automatically registers call in which the presented floor is set as the destination floor in the elevator 3 on which the user A gets. In this event, no destination button 10b needs to be operated. Immediately after the call is automatically registered, the destination presentation unit 22 ends presentation of guidance of the destination floor by blinking of the light emission equipment of the destination button 10b corresponding to the second floor. Further, for example, immediately after call is registered by the destination button 10b being operated, the destination presentation unit 22 ends presentation of guidance of the destination floor by blinking of the light emission equipment of the destination button 10b corresponding to the second floor.

Thereafter, as illustrated in FIG. 12B, the light emission equipment of the destination button 10b corresponding to the floor designated as the destination floor is lighted. In this event, registration of call is settled. For example, in a case where the destination button 10b corresponding to the destination floor presented by the destination presentation unit 22 is operated, when the car 7 stops on the destination floor, the destination presentation unit 22 may present guidance such as a video and a speech indicating information such as “the store P is on a right side after getting off the elevator 3 on this floor”.

Note that the destination presentation unit 22 may continue presentation of the destination when the destination button 10b corresponding to another floor which is not the presented destination floor is operated. Alternatively, for example, in a case where there is one user who is in the car 7, the destination presentation unit 22 may end presentation of the destination when the destination button 10b corresponding to another floor which is not the presented destination floor is operated.

Further, the destination presentation unit 22 may present the destination floor without using blinking of the light emission equipment of the destination button 10b. The destination presentation unit 22 may present the destination floor to the user, for example, through change of brightness of the light emission equipment of the destination button 10b corresponding to the destination floor, change of color tone of the light emission equipment, or the like.

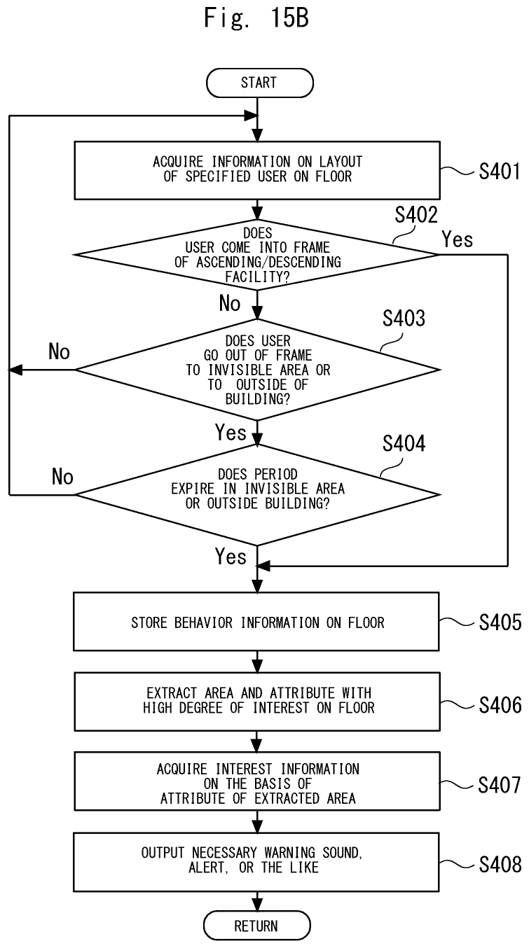

Subsequently, an example of operation of the guidance system 1 will be described using FIG. 13 to FIG. 15.

FIG. 13, FIG. 14, FIG. 15A and FIG. 15B are flowcharts illustrating an example of the operation of the guidance system 1 according to Embodiment 1.

FIG. 13 illustrates an example of the operation of the guidance system 1 related to judgement of the arrival floor, and the like, when the user utilizes the elevator 3.

In step S101, the user specification unit 14 specifies the user who enters the car 7 when a door of the car 7 of the elevator 3 is open. Then, the operation of the guidance system 1 proceeds to step S102.

In step S102, when the car 7 of the elevator 3 departs from one of the floors, the processing of the guidance system 1 starts. Here, the car 7 departs from one of the floors, for example, when the door of the car 7 closes on the floor. Then, the operation of the guidance system 1 proceeds to step S103.

In step S103, the user specification unit 14 settles specification of the user who is inside the car 7 of the elevator 3. Then, the operation of the guidance system 1 proceeds to step S104.

In step S104, the user specification unit 14 judges whether or not there is a user who is inside the car 7. In a case where the judgement result is Yes, the operation of the guidance system 1 proceeds to step S105. In a case where the judgement result is No, the user specification unit 14 judges that no user is inside the car 7, and the operation of the guidance system 1 proceeds to step S107.

In step S105, the ascending/descending facility judgement unit 17 judges that the ascending/descending facility to be utilized is the elevator 3 for the user specified by the user specification unit 14 in the car 7 of the elevator 3. Then, the operation of the guidance system 1 proceeds to step S106.

In step S106, the matching processing unit 18 performs matching processing on the user specified by the user specification unit 14. Then, the operation of the guidance system 1 proceeds to step S107.

In step S107, the floor judgement unit 19 stores a passenger state of the car 7 of the elevator 3 on the basis of the result of specification by the user specification unit 14. The passenger state of the car 7 includes, for example, whether or not the user is in the car 7, information to identify the user in a case where the user is in the car 7, and the like. Then, the operation of the guidance system 1 proceeds to step S108.

In step S108, the floor judgement unit 19 judges the departure floor and the arrival floor of the user on the basis of the passenger state stored in step S107 and the passenger state stored at the last minute. Then, the operation of the guidance system 1 proceeds to step S109.

In step S109, after the car 7 of the elevator 3 stops on one of the floors, the operation of the guidance system 1 proceeds to step S101.

FIG. 14 illustrates an example of operation of the guidance system 1 related to judgement of the arrival floor, and the like, when the user utilizes the escalator 4.

In step S201, when the user comes into a frame of the camera 12 provided at the exit of one of the escalators 4, the processing of the guidance system 1 starts. Then, the operation of the guidance system 1 proceeds to step S202.

In step S202, the user specification unit 14 specifies a user who is on the escalator 4 and settles specification of the user. Then, the operation of the guidance system 1 proceeds to step S203.

In step S203, the user specification unit 14 judges whether there is a user who is on the escalator 4. In a case where the judgement result is Yes, the operation of the guidance system 1 proceeds to step S204. In a case where the judgement result is No, the operation of the guidance system 1 proceeds to step S201.

In step S204, the floor judgement unit 19 judges whether the specified user is a user who has transferred the escalator 4. In a case where a preset period has not elapsed since the user had gone out of the frame of the camera 12 provided at an exit of another elevator 3, the floor judgement unit 19 judges that the user is a user who has transferred the escalator 4. In a case where the judgement result is No, the operation of the guidance system 1 proceeds to step S205. In a case where the judgement result is Yes, the operation of the guidance system 1 proceeds to step S208.

In step S205, the ascending/descending facility judgement unit 17 judges that the ascending/descending facility to be utilized is the escalator 4 for the user specified at the escalator 4 by the user specification unit 14. Then, the operation of the guidance system 1 proceeds to step S206.

In step S206, the matching processing unit 18 performs matching processing on the user specified by the user specification unit 14. Then, the operation of the guidance system 1 proceeds to step S207.

In step S207, the floor judgement unit 19 judges the floor on which the entrance of the escalator 4 is provided as the departure floor of the user. Then, the operation of the guidance system 1 proceeds to step 208.

In step S208, when the user goes out of the frame of the camera 12 provided at the exit of the escalator 4, the floor judgement unit 19 starts counting of a period from when the user goes out of the frame. Then, the operation of the guidance system 1 proceeds to step 209.

In step S209, the floor judgement unit 19 judges whether a period has expired, that is, whether the user does not come into a frame of the camera 12 of the next escalator 4 after the user has gone out of the frame, and a preset period has elapsed. In a case where the judgement result is No, the operation of the guidance system 1 proceeds to step S209 again. On the other hand, in a case where the judgement result is Yes, the operation of the guidance system 1 proceeds to step 210. Note that in a case where the user comes into a frame of another camera 12 on the floor on which the user gets off the escalator, other than the camera of the next escalator 4, the operation of the guidance system 1 may proceed to step S210.

In step S210, the floor judgement unit 19 judges the floor on which the exit of the escalator 4 is provided as the arrival floor of the user. Then, the operation of the guidance system 1 proceeds to step 201.

Note that also in a case where the user utilizes the stairs 5, the guidance system 1 judges the arrival floor, and the like, through similar processing.

FIG. 15 illustrates an example of the operation of the guidance system 1 related to acquisition, and the like, of the behavior information and the interest information on the arrival floor of the user.

In step S301 in FIG. 15A, when the arrival floor of the user is judged, the processing of the guidance system 1 starts. Then, the operation of the guidance system 1 proceeds to step S302.

In step S302, the user specification unit 14 judges whether there is a bird's-eye map of the arrival floor. In a case where the judgement result is No, the operation of the guidance system 1 proceeds to step S303. In a case where the judgement result is Yes, the operation of the guidance system 1 proceeds to step S305.

In step S303, the behavior information acquisition unit 15 starts acquisition of images from the cameras 12 provided on the arrival floor. Then, the operation of the guidance system 1 proceeds to step S304.

In step S304, the behavior information acquisition unit 15 generates a bird's-eye map from the acquired images. Then, the operation of the guidance system 1 proceeds to step S305.

In step S305, the user specification unit 14 judges whether the user who has arrived on the arrival floor can be specified on the bird's-eye map. In a case where the judgement result is No, the operation of the guidance system 1 proceeds to step S301. In a case where the judgement result is Yes, the operation of the guidance system 1 proceeds to step S306.

In step S306, the guidance system 1 acquires the behavior information and the interest information for the user specified in step S305. Here, in a case where a plurality of users are specified in step S305, the guidance system 1 may acquire the behavior information and the interest information in parallel for the plurality of users. Then, the operation of the guidance system 1 proceeds to step S301.

FIG. 15B illustrates an example of content of the processing in step S306 in FIG. 15A.

In step S401, the behavior information acquisition unit 15 acquires information on layout of the specified user. In this example, the behavior information acquisition unit 15 acquires information on coordinates of three feature amounts of at least both shoulders and the nose of the user. The behavior information acquisition unit 15 may acquire information on coordinates of other feature amounts of the user. Then, the operation of the guidance system 1 proceeds to step S402.

In step S402, the behavior information acquisition unit 15 judges whether the user comes into the frame of the ascending/descending facility. Note that when the user comes into the frame of the ascending/descending facility, the user goes out of a frame on the floor on which the user is located. In a case where the judgement result is No, the operation of the guidance system 1 proceeds to step S403. In a case where the judgement result is Yes, the operation of the guidance system 1 proceeds to step S405.

In step S403, the behavior information acquisition unit 15 judges whether the user goes out of the frame to the invisible area or to outside from an entrance of the building 2. In a case where the judgement result is No, the operation of the guidance system 1 proceeds to step S401. In a case where the judgement result is Yes, the operation of the guidance system 1 proceeds to step S404.

In step S404, the behavior information acquisition unit 15 judges whether a period has expired, that is, whether a preset period has elapsed since the user had gone out of the frame to the invisible area or to outside from the entrance of the building 2. In a case where the judgement result is No, the operation of the guidance system 1 proceeds to step S401. In a case where the judgement result is Yes, the operation of the guidance system 1 proceeds to step S405.

In step S405, the behavior information acquisition unit 15 completes acquisition of the behavior information. The behavior information storage unit 16 stores the acquired behavior information for each user as time-series data. Then, the operation of the guidance system 1 proceeds to step S406.

In step S406, the interest information acquisition unit 20 extracts an area for which the user has a high degree of interest on the basis of the behavior information of the user. Then, the operation of the guidance system 1 proceeds to step S407.

In step S407, the interest information acquisition unit 20 refers to an attribute of the area for which the user has a high degree of interest from the attribute storage unit 13. The interest information acquisition unit 20 acquires the interest information on the basis of information on the degree of interest of the user and the referred attribute. The interest information storage unit 21 stores the acquired interest information for each user. In this event, the interest information storage unit 21 may update the interest information for each user with the acquired interest information. Then, the operation of the guidance system 1 proceeds to step S408.

In step S408, the guidance system 1 outputs warning sound, an alert, or the like, as necessary. The warning sound, alert, or the like, is output, for example, in a case where mismatch occurs between an event in which the user comes into a frame and an event in which the user goes out of a frame. A case where mismatch occurs between an event in which the user comes into a frame and an event in which the user goes out of a frame includes, for example, a case where the user who comes into a frame is not judged to go out of the frame, a case where the user who does not come into a frame is judged to go out of the frame, and the like. In a case where it is not necessary to output warning sound, an alert, or the like, the processing in step S408 may be skipped. Then, the operation of the guidance system 1 related to acquisition of the behavior information and the interest information for each user ends.

As described above, the guidance system 1 according to Embodiment 1 includes the attribute storage unit 13, the user specification unit 14, the floor judgement unit 19, the behavior information acquisition unit 15, the interest information acquisition unit 20, the interest information storage unit 21, and the destination presentation unit 22. The attribute storage unit 13 stores attributes for each area for each floor of the building 2. The user specification unit 14 specifies the user in the building 2 on the basis of the image captured by at least one of the cameras 12 provided in the building 2. When the specified user moves from the departure floor to the arrival floor by utilizing one of the ascending/descending facilities, the floor judgement unit 19 judges the arrival floor of the user on the basis of the image captured by one of the cameras 12 including at least the camera 12 inside the car 7 of the elevator 3, the camera 12 on the floor on which the user gets off the escalator 4, and the camera 12 on the floor on which the user finishes utilization of the stairs 5. The behavior information acquisition unit 15 acquires behavior information representing behavior of the user on the judged arrival floor for the specified user on the basis of the image captured by at least one of the cameras 12. The interest information acquisition unit 20 acquires interest information representing a degree of interest of the user for each attribute on the basis of a relationship between layout of areas and attributes of the areas on the judged arrival floor and the behavior information for the specified user. The interest information storage unit 21 stores the interest information acquired by the interest information acquisition unit 20 for each user. The destination presentation unit 22 preferentially presents an area with an attribute with a higher degree of interest to the user as the destination when the user specification unit 14 specifies the user who starts utilization of one of the ascending/descending facilities. The destination is presented by the destination presentation unit on the basis of the interest information stored in the interest information storage unit 21 for the user and information on the attributes stored in the attribute storage unit 13.

According to such a configuration, specification of the user, judgement of the arrival floor and acquisition of the behavior information are performed on the basis of the images captured by the cameras 12 provided in the building 2, so that behavior information on the arrival floor is acquired also for users who do not operate equipment of the ascending/descending facilities. Further, the interest information is acquired on the basis of the behavior information of the user. Thus, the interest information is acquired also for users who do not operate equipment of the ascending/descending facilities. The destination presentation unit 22 presents the destination on the basis of the interest information for each user acquired in this manner, so that it is possible to guide users who do not operate the ascending/descending facilities in the building 2 as well on the basis of the interest of the users. Further, these kinds of processing are performed on the basis of the captured images, and thus, acquisition of the interest information and guidance to the destination can be performed also for users who do not possess information terminals, and the like. Still further, even in the building 2 in which the elevator 3, the escalator 4 and the stairs 5 are mixed, the guidance system 1 manages history of getting on and getting off the ascending/descending facilities by integrating the elevator 3, the escalator 4 and the stairs 5 as the ascending/descending facilities, so that interest information of the users are more reliably acquired.

Further, the guidance system 1 includes the ascending/descending facility judgement unit 17 and the matching processing unit 18. The ascending/descending facility judgement unit 17 judges the ascending/descending facility to be utilized by the user on the basis of the image captured by at least one of the cameras 12 when the user specified by the user specification unit 14 starts utilization of one of the ascending/descending facilities. Here, there is a case where the ascending/descending facility judgement unit 17 judges two or more ascending/descending facilities at the same time as facilities to be utilized by the users specified as the same user by the user specification unit 14. In this case, the matching processing unit 18 causes the user specification unit 14 to specify the users who utilize the two or more ascending/descending facilities as users different from each other. When the user specification unit 14 specifies the users as users different from each other, the user specification unit 14 extracts a difference in feature amounts of the users from the acquired images, improves accuracy of specification of the users and resettles specification of the users different from each other.

According to such a configuration, accuracy of specification of the user becomes higher. Thus, guidance of the user is more reliably performed.

Further, the guidance system 1 includes the call registration unit 23. The call registration unit 23 registers call to the destination floor including the destination presented by the destination presentation unit 22 in the elevator 3 that is the ascending/descending facility.

According to such a configuration, the user can move to the destination without operating the ascending/descending facility. This further improves convenience of the user.

Further, the interest information acquisition unit 20 acquires interest information of the user every time the behavior information acquisition unit 15 completes acquisition of the behavior information of the user on the arrival floor.

According to such a configuration, behavior of the user on the arrival floor is reflected in the interest information in real time. Thus, the guidance system 1 can perform guidance while quickly reflecting interest of the user.

Note that the guidance system 1 includes the behavior information storage unit 16. The behavior information storage unit 16 stores the behavior information acquired by the behavior information acquisition unit 15 for each user. In this event, the interest information acquisition unit 20 may read the behavior information for each user from the behavior information storage unit 16 at a preset timing. The interest information acquisition unit 20 acquires interest information of the user on the basis of the read behavior information. Here, the preset timing is, for example, a time point set in advance in hours such as nighttime during which there are few users in the building 2, or the like. Processing of acquiring, or the like, the interest information is performed during hours in which there are few users, so that load of the processing in the guidance system 1 is temporally dispersed. Further, in a case where the interest information acquisition unit 20 or the interest information storage unit 21 is installed on equipment connected from equipment in the building 2 through a network, the behavior information, and the like, are transmitted to the interest information acquisition unit 20 or the interest information storage unit 21 during hours in which communication load on the network is light. Thus, even in a case where the network has few communication capacity, it is possible to reduce communication load on the network.

Further, in a case where the user possesses a portable information terminal, or the like, having a wireless communication function, or the like, the user specification unit 14 may accessorily utilize identification information, or the like, acquired from the information terminal through wireless communication. The information terminal possessed by the user may be, for example, a smartphone, or the like. For example, an electromagnetic wave from outside is shielded inside the car 7 of the elevator 3. In this event, an electromagnetic wave received inside the car 7 of the elevator 3 is highly likely to be an electromagnetic wave from the information terminal of the user who is inside the car 7. By accessorily utilizing such information, the user specification unit 14 can improve accuracy of specification of the user. In a case where the user possesses an information terminal, the destination presentation unit 22 may present the destination by transmitting information, or the like, to be displayed on the information terminal. In this event, the destination presentation unit 22 may issue information without specifying a receiver through broadcast communication, or the like, of a wireless beacon, for example, provided at the hall, or the like, of the elevator 3.

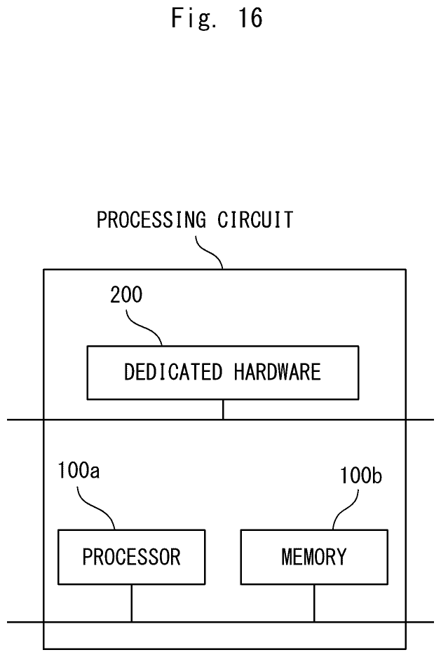

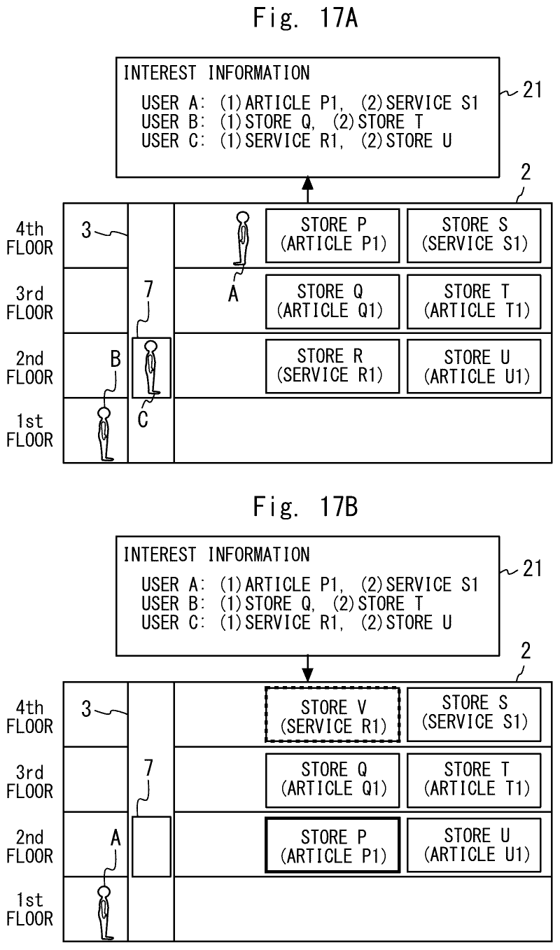

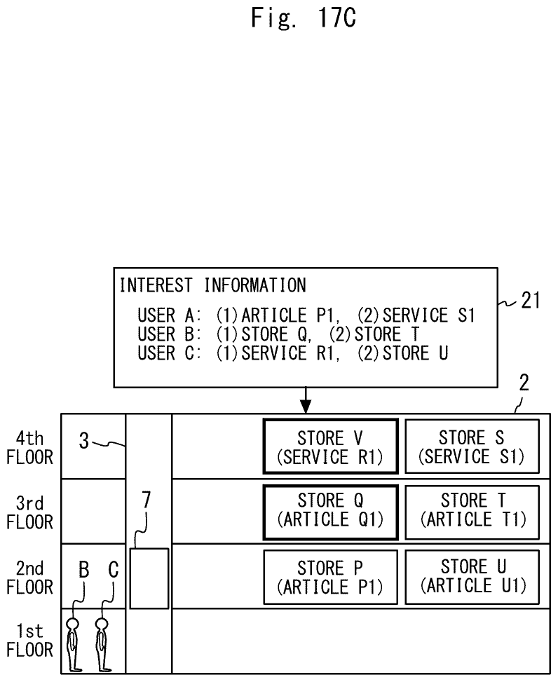

Subsequently, an example of a hardware configuration of the guidance system 1 will be described using FIG. 16.

FIG. 16 is a hardware configuration diagram of main portions of the guidance system 1 according to Embodiment 1.

Each function of the guidance system 1 can be implemented by a processing circuit. The processing circuit includes at least one processor 100a and at least one memory 100b. The processing circuit may include at least one piece of dedicated hardware 200 along with or as a substitute for the processor 100a and the memory 100b.

In a case where the processing circuit includes the processor 100a and the memory 100b, each function of the guidance system 1 is implemented by software, firmware or a combination of the software and the firmware. At least one of the software or the firmware is described as a program. The program is stored in the memory 100b. The processor 100a implements each function of the guidance system 1 by reading out and executing the program stored in the memory 100b.

The processor 100a will be also referred to as a central processing unit (CPU), a processing device, an arithmetic device, a microprocessor, a microcomputer or a DSP. The memory 100b is constituted with, for example, a non-volatile or volatile semiconductor memory such as a RAM, a ROM, a flash memory, an EPROM and an EEPROM. Here, the processor 100a and the memory 100b may be separated or does not have to be separated. For example, the processor 100a may include the memory 100b. Further, a device in which the processor 100a and the memory 100b are merged may be used.

In a case where the processing circuit includes the dedicated hardware 200, the processing circuit is implemented with, for example, a single circuit, a composite circuit, a programmed processor, a parallel programmed processor, an ASIC, an FPGA, a combination thereof or a circuit capable of performing processing equivalent to this.

The respective functions of the guidance system 1 can be each implemented with the processing circuit. Alternatively, the respective functions of the guidance system 1 can also be collectively implemented with the processing circuit. Part of the respective functions of the guidance system 1 may be implemented with the dedicated hardware 200, and the other may be implemented with software or firmware. In this manner, the processing circuit implements each function of the guidance system 1 with the dedicated hardware 200, the software, the firmware or a combination thereof.

Differences from examples disclosed in other embodiments will be described particularly in detail for each of embodiments which will be described below. For characteristics that are not described in each of the following embodiments, any characteristic in the examples disclosed in other embodiments may be employed.

### Embodiment 2

In the guidance system 1 in this example, guidance is performed in accordance with a level of interest included in the interest information.

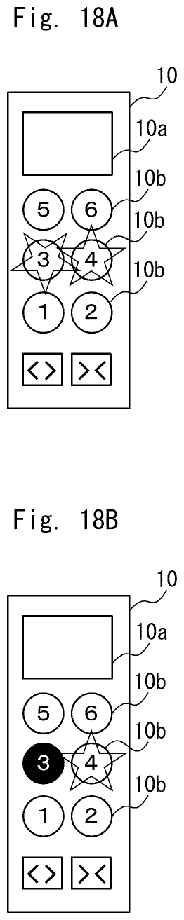

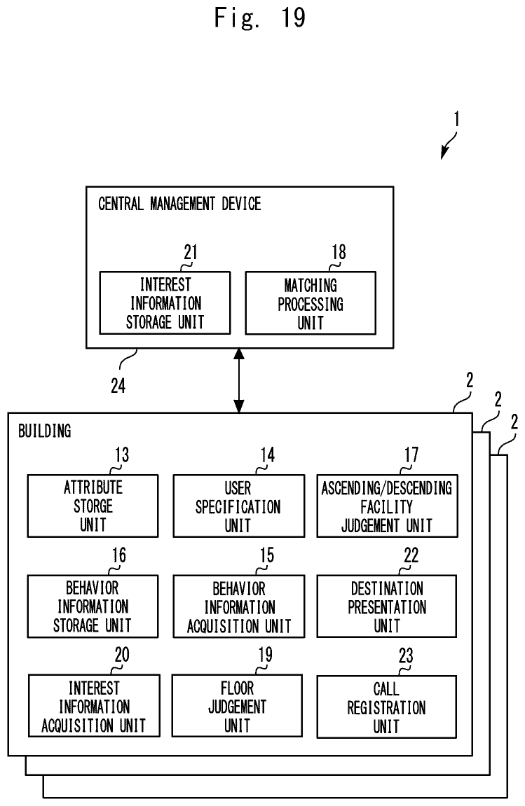

FIG. 17A to FIG. 17C and FIG. 18A to FIG. 18B are views illustrating an example of presentation of the destination by the guidance system 1 according to Embodiment 2.

FIG. 17 illustrate an example of the building 2 to which the guidance system 1 is to be applied.

FIG. 17A illustrates the building 2 at a certain date. In this building 2, a store P that deals with an article P1 and a store S that provides a service S1 are open in areas on the fourth floor. Further, a store Q that deals with an article Q1 and a store T that deals with an article T1 are open in areas on the third floor. Still further, a store R that provides a service R1 and a store U that deals with an article U1 are open in areas on the second floor.

Until this date, the guidance system 1 acquires interest information of the user A, the user B and the user C. The interest information storage unit 21 stores the article P1 as an attribute with the highest degree of interest, and the service S1 as an attribute with the second highest degree of interest for the user A. The interest information storage unit 21 stores the store Q as an attribute with the highest degree of interest and the store T as an attribute with the second highest degree of interest for the user B. The interest information storage unit 21 stores the service R1 as an attribute with the highest degree of interest and the store U as an attribute with the second highest degree of interest for the user C.

FIG. 17B illustrates the same building 2 at a later date. By this date, the store P that deals with the article P1 has moved to an area on the second floor. Further, the store R has been closed. Still further, a store V that provides the service R1 has been open in an area on the fourth floor.

The user A who visits the building 2 again at this date is specified by the user specification unit 14 at the hall of the elevator 3 on the first floor. In this event, the destination presentation unit 22 reads the interest information for the user A from the interest information storage unit 21. The destination presentation unit 22 in this example preferentially presents an area with a higher degree of interest to the user as the destination. Thus, the destination presentation unit 22 acquires the article P1 as the attribute with the highest degree of interest and the service S1 as the attribute with the second highest degree of interest for the user A. The destination presentation unit 22 extracts an area having the article P1 as the attribute from the attribute storage unit 13. In this example, the destination presentation unit 22 extracts the area on the second floor in which the moved store P is open as the destination with the highest priority. Further, the destination presentation unit 22 extracts an area having the service S1 as the attribute from the attribute storage unit 13. In this example, the destination presentation unit 22 extracts the area on the fourth floor in which the store S is open as the destination with the second highest priority. The destination presentation unit 22 presents the extracted areas to the user A as the destination.

As illustrated in FIG. 17C, the user B and the user C who visit the building 2 again at the same date are specified by the user specification unit 14 at the hall of the elevator 3 on the first floor. In this event, the destination presentation unit 22 reads the interest information for each of the user B and the user C from the interest information storage unit 21. The destination presentation unit 22 in this example presents areas with the highest degrees of interest for the respective users as destinations when the destination presentation unit 22 presents the destinations to a plurality of users at the same time. Thus, the destination presentation unit 22 acquires the store Q as an attribute with the highest degree of interest for the user B. The destination presentation unit 22 extracts the area of the store Q as the attribute from the attribute storage unit 13. In this example, the destination presentation unit 22 extracts the area on the third floor in which the store Q is open as the destination to be presented to the user B. Further, the destination presentation unit 22 acquires the service R1 as an attribute with the highest degree of interest for the user C. The destination presentation unit 22 extracts the area of the store V that provides the service R1 as the attribute from the attribute storage unit 13. In this example, the destination presentation unit 22 extracts the area on the fourth floor in which the store V is open as the destination to be presented to the user C.

FIG. 18 illustrate an example of presentation of the destinations through the car operating panel 10. In this example, the third floor and the fourth floor are presented to the user B and the user C who get on the car 7 as the destination floors.

As illustrated in FIG. 18A, the destination presentation unit 22 calls for attention to guidance before the third floor and the fourth floor are registered as the destination floors, to the user B and the user C by causing light emission equipment of the destination buttons 10b corresponding to the third floor and the fourth floor to blink. In this event, the destination presentation unit 22 may display a video such as “the store Q is on the third floor, and the store V that provides the service R1 is on the fourth floor” together on display equipment such as a display panel 10a. Further, the destination presentation unit 22 may cause a built-in speaker of the display equipment such as the display panel 10a to present guidance using a speech together. Here, for example, immediately after call is automatically registered after a preset period has elapsed since presentation by blinking of the light emission equipment had been started, the destination presentation unit 22 ends presentation of guidance of the destination floors by blinking of the light emission equipment of the destination buttons 10b corresponding to the third floor and the fourth floor. Further, for example, immediately after call is registered by the destination buttons 10b being operated, the destination presentation unit 22 ends presentation of guidance of the destination floors by blinking of the light emission equipment of the destination buttons 10b corresponding to the third floor and the fourth floor.

For example, in a case where call is registered by the destination button 10b corresponding to the third floor being operated by the user B, as illustrated in FIG. 18B, the light emission equipment of the destination button 10b corresponding to the floor designated as the destination floor is lighted. Here, for example, in a case where the destination button 10b corresponding to the fourth floor that is the presented destination floor is not operated, the destination presentation unit 22 may continue to present the destination floor by blinking of the light emission equipment of the destination button 10b corresponding to the fourth floor. In this event, after a preset period has elapsed since presentation by blinking of the light emission equipment had been started, the call registration unit 23 automatically registers call in which the fourth floor is set as the destination floor, in the elevator 3 on which the user C gets. Immediately after the call in which the fourth floor is set as the destination floor is automatically registered, the light emission equipment of the destination button 10b corresponding to the fourth floor is lighted.

Here, if the floor to which the user B or the user C desires to go is not the automatically registered destination floor, the user B or the user C can cancel the destination button 10b of the automatically registered destination floor and can register other destination floors. For example, if the destination button 10b corresponding to the third floor is cancelled, the user B and the user C get off the elevator 3 on the fourth floor that is the remaining destination floor. By this means, the user B or the user C can change the floor on which the user B or the user C is to get off the elevator 3 regardless of the degree of interest. In this event, the floors on which the user B and the user C get off the elevator 3 are judged. This enables acquisition of the behavior information and the interest information on the floors on which the user B and the user C get off the elevator 3 for the user B and the user C.

Note that in a case where the destination presentation unit 22 presents a plurality of destinations to the user A, or the like, the destination presentation unit 22 may present destination floors by causing a plurality of destination buttons 10b respectively corresponding to the destination floors such as the second floor and the fourth floor to blink. In this event, the destination presentation unit 22 may cause the destination buttons 10b to adjust blinking, color tone or brightness of the light emission equipment, speed of change thereof, or the like, in accordance with priority of the destinations.

Here, for example, in a case where no destination floor is designated until a preset period has elapsed since presentation by blinking of the light emission equipment had been started, the call registration unit 23 automatically registers the call in which the second floor presented as the destination floor with the highest priority is set as the destination floor, in the elevator 3. If the floor to which the user A desires to go is not the automatically registered destination floor, the user A may cancel the destination button 10b of the automatically registered destination floor and may register other destination floors.

### Embodiment 3

In the guidance system 1 in this example, guidance is performed across a plurality of buildings 2.

FIG. 19 is a configuration diagram of the guidance system 1 according to Embodiment 3.

In the guidance system 1, the attribute storage unit 13, the user specification unit 14, the behavior information acquisition unit 15, the behavior information storage unit 16, the ascending/descending facility judgement unit 17, the floor judgement unit 19, the interest information acquisition unit 20, the destination presentation unit 22, and the call registration unit 23 are applied to each building 2 as parts that perform data processing. These portions perform operation such as specification of the user, acquisition of behavior information and interest information, presentation of the destination and registration of call in each building 2.

The guidance system 1 includes a central management device 24. The central management device 24 is a device that integrates and manages information such as interest information acquired in the plurality of buildings 2. The central management device 24 is, for example, one or more server devices. Part or all of the central management device 24 may be installed on virtual machine, or the like, on a cloud service. The central management device 24 includes the matching processing unit 18 and the interest information storage unit 21.

The matching processing unit 18 has a function of achieving matching in specification of users by the user specification units 14 applied to the respective buildings 2. Processing of achieving matching is, for example, performed as follows. There is a possibility that the user specification units 14 applied to the respective buildings 2 erroneously specify different users as the same user. There is a possibility that the user specification units 14 applied to different buildings 2 specify the same user at the same time. The same person cannot redundantly exist in two or more buildings 2 at the same time, and thus, the matching processing unit 18 requests the user specification units 14 applied to the respective buildings 2 to modify specification of the users. In this event, the user specification units 14 applied to the respective buildings 2 specify the users erroneously specified as the same user, as users different from each other. When the user specification units 14 specify the users as users different from each other, the user specification units 14 extract a difference in feature amounts of the users from the acquired images, improve accuracy of specification of users, and resettle specification of the users different from each other. Note that the matching processing unit 18 may also perform processing of achieving matching between specification of the user by the user specification unit 14 and judgement of the ascending/descending facility to be utilized by the user by the ascending/descending facility judgement unit 17 for each building 2.

The interest information storage unit 21 integrates the interest information acquired in the respective buildings 2 and stores the integrated interest information for each user. The interest information storage unit 21 stores, for example, identification information unique to the users and the interest information of the users in association with each other.

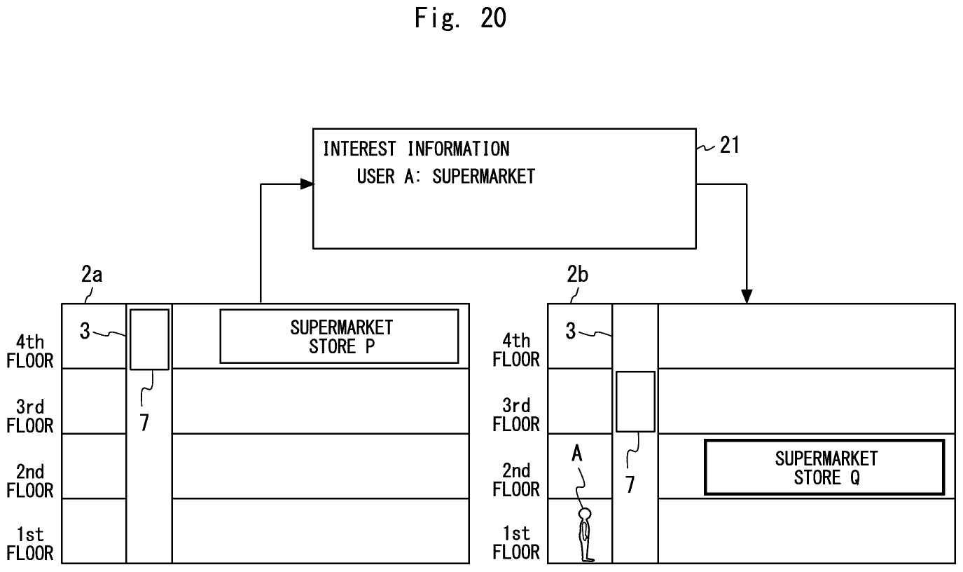

Subsequently, an example of presentation of the destination to the user will be described using FIG. 20.

FIG. 20 is a view illustrating an example of presentation of the destination by the guidance system 1 according to Embodiment 3.

FIG. 20 illustrates an example of a plurality of buildings 2 to which the guidance system 1 is to be applied.

In this example, a plurality of buildings at a certain date are illustrated. The user A visits one building 2a a plurality of times until this date. The user A visits another building 2b for the first time at this date. In the building 2a, a store P which is a supermarket is open on the fourth floor. In the building 2b, a store Q which is a supermarket is open on the second floor.

Until this date, the guidance system 1 acquires interest information of the user A who has visited the building 2a. Here, the building 2a in which the interest information, and the like, of the user is acquired is an example of a first building. A first camera is the camera 12 provided in the first building. A first attribute storage unit is the attribute storage unit 13 applied to the first building. A first user specification unit is the user specification unit 14 applied to the first building. The interest information acquisition unit 20 of the building 2a transmits the acquired interest information to the interest information storage unit 21 of the central management device 24. The interest information storage unit 21 integrates the interest information received from the interest information acquisition unit 20 of the building 2a and stores the integrated interest information for each user. The interest information storage unit 21 may integrate and store interest information received from the interest information acquisition units 20 applied to the buildings 2 other than the building 2a and the building 2b. The interest information storage unit 21 stores a supermarket as an attribute with the highest degree of interest for the user A who has visited the building 2a, and the like.

The user A who visits the building 2b for the first time at this date is specified by the user specification unit 14 of the building 2b at the hall of the elevator 3 on the first floor. In this event, the destination presentation unit 22 of the building 2b reads the interest information for the user A from the interest information storage unit 21. The destination presentation unit 22 in this example presents an area with the attribute with the highest degree of interest to the user as the destination. Thus, the destination presentation unit 22 acquires a supermarket as the attribute with the highest degree of interest of the user A. The destination presentation unit 22 extracts an area having a supermarket as the attribute from the attribute storage unit 13 of the building 2b. In this example, the destination presentation unit 22 extracts an area on the second floor in which the store Q is open in the building 2b. The destination presentation unit 22 presents the extracted area to the user A as the destination. The call registration unit 23 of the building 2b registers call to the destination floor in the elevator 3, for example, in a case where the user who gets on the car 7 of the elevator 3 of the building 2b does not operate the car operating panel 10, or the like. Here, the building 2b in which presentation, and the like, of the destination to the user is performed is an example of a second building. A second camera is the camera 12 provided in the second building. A second user specification unit is the user specification unit 14 applied to the second building. A second attribute storage unit is the attribute storage unit 13 applied to the second building. Note that the second building does not have to be a building visited by the user A for the first time. In the second building, interest information, and the like, of the user may be acquired in the past.

As described above, the guidance system 1 according to Embodiment 3 includes the attribute storage units 13, the user specification units 14, the floor judgement units 19, the behavior information acquisition units 15, the interest information acquisition units 20, the interest information storage units 21 and the destination presentation units 22 corresponding to the respective buildings 2. Each attribute storage unit 13 stores attributes for each area for each floor of the corresponding building 2. Each user specification unit 14 specifies the user in the building 2 on the basis of the image captured by at least one of the cameras 12 provided in the corresponding building 2. The floor judgement unit 19 judges the arrival floor of the user on the basis of the image captured by at least one of the cameras 12 when the user specified in one of the buildings 2 moves from the departure floor to the arrival floor by utilizing the ascending/descending facility of the building 2. The behavior information acquisition unit 15 acquires behavior information representing behavior of the user on the judged arrival floor on the basis of the image captured by at least one of the cameras 12 for the user specified in one of the buildings 2. The interest information acquisition unit 20 acquires interest information representing a degree of interest of the user for each attribute on the basis of a relationship between layout of areas on the judged arrival floor and attributes of the areas, and the behavior information for the user specified in one of the buildings 2. The interest information storage unit 21 stores the interest information acquired by the interest information acquisition unit 20 for each user. The destination presentation unit 22 preferentially presents an area with a higher degree of interest to the user as the destination when the user specification unit 14 specifies the user who starts utilization of the ascending/descending facility in one of the buildings 2. The destination is presented by the destination presentation unit 22 on the basis of the interest information stored in the interest information storage unit 21 for the user and information on the attributes stored in the attribute storage unit 13. The destination presentation unit 22 presents the destination to the user by utilizing part or all of the interest information of the user acquired in each building 2.

According to such a configuration, specification of the user, judgement of the arrival floor and acquisition of the behavior information are performed on the basis of the images captured by the cameras 12 provided in the building 2, so that the behavior information on the arrival floor is acquired also for users who do not operate equipment of the ascending/descending facilities. Further, the interest information is acquired on the basis of the behavior information of users. Thus, the interest information is acquired for users who do not operate equipment of the ascending/descending facilities. The destination presentation unit 22 presents the destination on the basis of the interest information for each user acquired in this manner, so that it is possible to guide users who do not operate the ascending/descending facilities in the building 2 as well on the basis of interest of the users. Further, these kinds of processing are performed on the basis of the captured images, so that acquisition of interest information and guidance of the destination can be performed also for users who do not possess information terminals, or the like. Still further, also in the building 2 in which the elevator 3, the escalator 4 and the stairs 5 are mixed, the guidance system 1 manages history of getting on and getting off the ascending/descending facilities by integrating the elevator 3, the escalator 4 and the stairs 5 as the ascending/descending facility, so that interest information of the users are more reliably acquired. Further, the interest information of the user is shared among the plurality of buildings 2, so that the guidance system 1 can present the destination on the basis of interest also for a user who visits the building 2 for the first time.

### Embodiment 4

In the guidance system 1 in this example, interest information is provided to an external system 99.

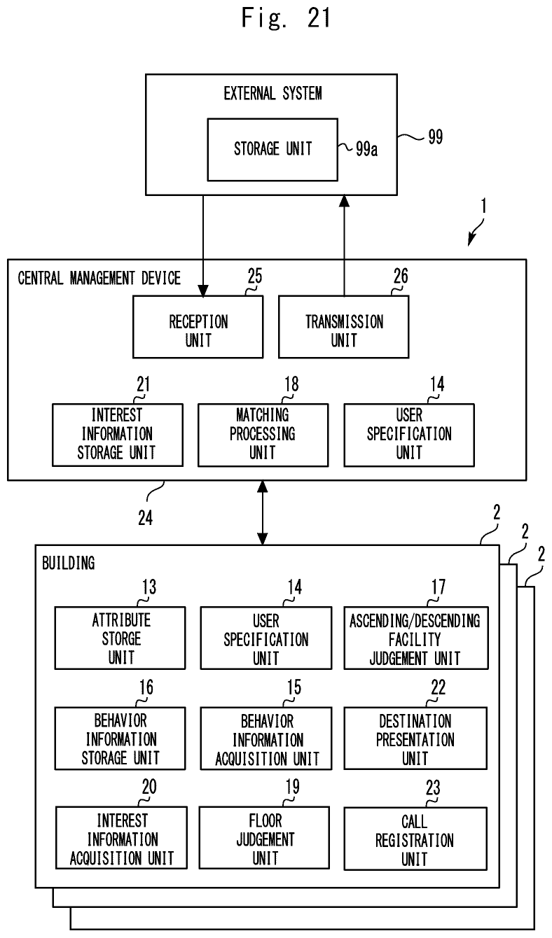

FIG. 21 is a configuration diagram of the guidance system 1 according to Embodiment 4.

The external system 99 is an external system of the guidance system 1. The external system 99 is a system that presents a destination in accordance with a degree of interest of the user. The external system 99 may have a configuration similar to the configuration of the guidance system 1. The external system 99 is applied to the building 2 to which the guidance system 1 is not applied. In the building 2 to which the external system 99 is applied, a plurality of cameras 12 that capture images of the user are provided. The external system 99 includes a storage unit 99a. The storage unit 99a daily stores images of each area of the building 2 to which the external system 99 is applied and performs updating. The external system 99 transmits an image with no person, for example, an updated image of each area on each floor acquired at midnight to the guidance system 1. Further, the external system 99 continuously transmits an image captured by each camera 12 of the building 2 to which the external system 99 is applied to the guidance system 1, for example, from the morning to the night. The image transmitted here does not have to be particularly processed. The external system 99 receives candidates for the destination from the guidance system 1 that receives transmission of the image and specifies the user.

The central management device 24 includes a reception unit 25, a transmission unit 26, the user specification unit 14, the matching processing unit 18 and the interest information storage unit 21. The reception unit 25 and the transmission unit 26 are parts that perform communication with the external system 99. By this means, the central management device 24 provides an interface to the external system 99.

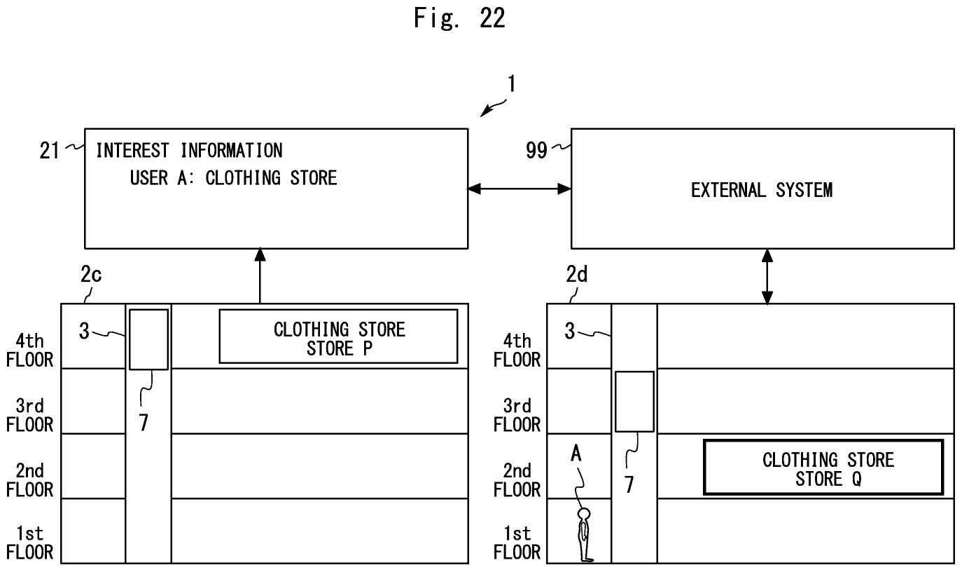

Subsequently, an example of provision of the interest information to the external system 99 will be described using FIG. 22.

FIG. 22 is a view illustrating an example of provision of the interest information by the guidance system 1 according to Embodiment 4.

FIG. 22 illustrates an example of a building 2c to which the guidance system 1 is to be applied and a building 2d to which the external system 99 is to be applied. The building 2d to which the external system 99 is to be applied is an example of a third building.

In this example, the building 2c and the building 2d at a certain date are illustrated. The user A has visited the building 2c a plurality of times until this date. The user A visits the building 2d for the first time at this date. In the building 2c, a store P which is a clothing store is open on the fourth floor. A store Q which is a clothing store is open on the second floor in the building 2d.

Until this date, the guidance system 1 acquires interest information of the user A who has visited the building 2c, and the like. Here, the building 2c in which the interest information, and the like, of the user are acquired is an example of the first building. The interest information storage unit 21 stores a clothing store as an attribute with the highest degree of interest for the user A who has visited the building 2c, and the like.

For example, in the early hours of this date, the external system 99 transmits in advance images of each area on each floor of the building 2d to the guidance system 1. The guidance system 1 that receives the images generates in advance a bird's-eye map of the building 2d in a similar manner to that illustrated in FIG. 8.

Images of the user A who visits the building 2d for the first time at this date are captured by the cameras 12 provided in the building 2d. The cameras 12 are, for example, provided at the hall of the elevator 3, and the like. The external system 99 transmits the images of the user A to the central management device 24.

The reception unit 25 of the central management device 24 receives the images of the user A from the external system 99. The user specification unit 14 of the central management device 24 specifies the user A on the basis of the images received from the external system 99. The user specification unit 14 of the central management device 24 that specifies the user on the basis of the images received from the external system 99 is an example of a third user specification unit. The user specification unit 14 of the central management device 24 determines a coordinate of the user A on the bird's-eye map of the building 2d after specifying the user A. Further, the transmission unit 26 reads the interest information of the specified user A from the interest information storage unit 21, specifies an attribute with the highest degree of interest corresponding to each area on each floor on the bird's-eye map of the building 2d as interest information, and transmits candidates for the destination in the building 2d to the external system 99. The transmission unit 26 transmits information indicating that the attribute with the highest degree of interest of the user A who is the user specified by the images is a clothing store, to the external system 99.

The external system 99 receives the candidates for the destination in the building 2d from the central management device 24. In this example, the external system 99 receives information indicating that the attribute with the highest degree of interest of the user A among the areas and the attributes thereof in the building 2d is a clothing store. Thus, the external system 99 presents the store Q which is a clothing store to the user A who visits the building 2d as the destination. Note that the building 2d to which the external system 99 is applied does not have to be a building visited by the user A for the first time.

As described above, the guidance system 1 according to Embodiment 4 includes the attribute storage unit 13, the user specification unit 14 corresponding to the building 2 to which the guidance system 1 is applied, the floor judgement unit 19, the behavior information acquisition unit 15, the interest information acquisition unit 20, the interest information storage unit 21, the reception unit 25, the user specification unit 14 of the central management device 24 and the transmission unit 26. The attribute storage unit 13 stores attributes for each area for each floor of the corresponding building 2. The user specification unit 14 specifies the user in the building 2 on the basis of the image captured by at least one of the cameras 12 provided in the corresponding building 2. The floor judgement unit 19 judges the arrival floor of the user on the basis of the image captured by at least one of the cameras 12 when the specified user moves from the departure floor to the arrival floor by utilizing one of the ascending/descending facilities. The behavior information acquisition unit 15 acquires behavior information representing behavior of the user on the judged arrival floor on the basis of the image captured by at least one of the cameras 12 for the specified user. The interest information acquisition unit 20 acquires interest information representing a degree of interest of the user for each attribute on the basis of a relationship between layout of areas on the judged arrival floor and the attributes of the areas, and the behavior information for the specified user. The interest information storage unit 21 stores the interest information acquired by the interest information acquisition unit 20 for each user. The reception unit 25 sequentially receives images necessary for generating a bird's-eye map of each area on each floor in the building 2d to which the external system 99 is applied, and images of the user who starts utilization of the ascending/descending facility from the external system 99. The user specification unit 14 of the central management device 24 specifies the user on the basis of the images received by the reception unit 25. The transmission unit 26 reads the interest information stored in the interest information storage unit 21 for the user specified by the user specification unit 14 of the central management device 24, specifies an attribute with the highest degree of interest corresponding to each area on each floor on the bird's-eye map of the building 2d as interest information and transmits candidates for the destination in the building 2d to the external system 99.

According to such a configuration, specification of the user, judgement of the arrival floor and acquisition of the behavior information are performed on the basis of the images captured by the cameras 12 provided in the building 2, so that behavior information on the arrival floor is acquired also for users who do not operate equipment of the ascending/descending facilities. Further, the interest information is acquired on the basis of the behavior information of the user. Thus, the interest information is acquired also for users who do not operate equipment of the ascending/descending facilities. The transmission unit 26 provides the candidates for the destination for each user acquired in this manner to the building 2d to which the external system 99 is applied. This enables guidance in the building 2d on the basis of interest of users also for the users who do not operate the ascending/descending facilities. Further, the guidance system 1 does not request identification information, and the like, other than the images of the user to the external system 99. This enables the guidance system 1 to perform guidance to an area with the highest degree of interest in the building 2d for each user without providing personal information such as name that identifies the user to the external system 99.

### Embodiment 5

When a plurality of users gather and behave as a group, there is a case where the users perform behavior different from behavior as individual users. In the guidance system 1 in this example, a group including a plurality of users is guided.

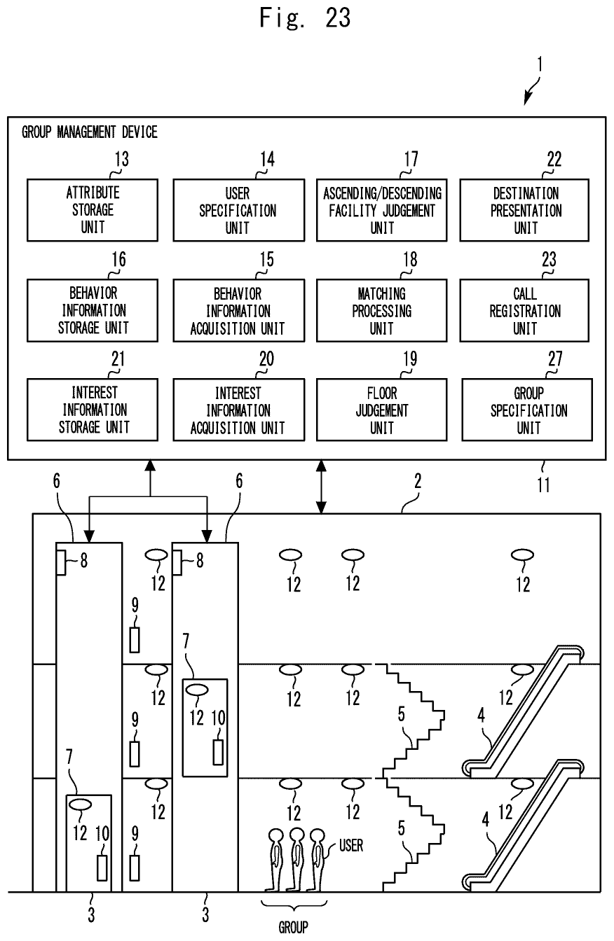

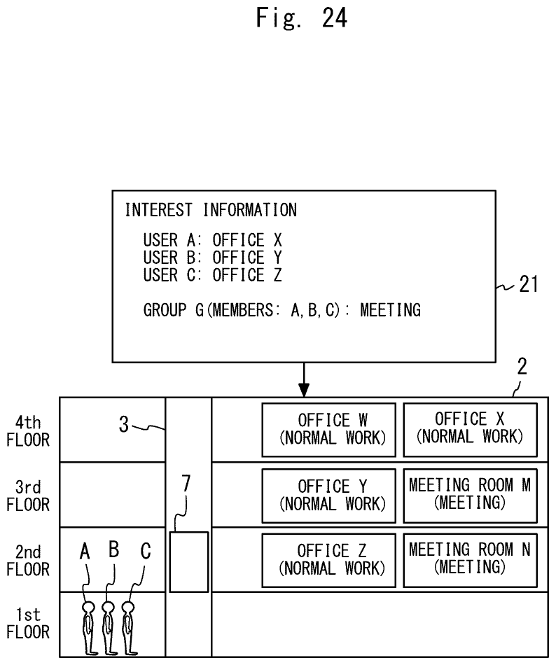

FIG. 23 is a configuration diagram of the guidance system 1 according to Embodiment 5.

The guidance system 1 includes a group specification unit 27 as a part that performs data processing. In this example, the group specification unit 27 is installed on the group management device 11.

The group specification unit 27 has a function of specifying a group that behaves in the building 2. The group includes a plurality of users specified by the user specification unit 14.

The group specification unit 27 registers a group, for example, as follows. The group specification unit 27 registers a plurality of users staying in one of the areas of the building 2 for a period longer than a time threshold set in advance, as a group that has spent in the area. Here, the area in which the group spends in the building 2 is an area on the arrival floor judged by the floor judgement unit 19 for the users included in the group as members. The area in which the group spends in the building 2 is, for example, a meeting room, or the like, in a case where the building 2 is an office building, or the like. Alternatively, in a case where the building 2 includes a restaurant, or the like, the area in which the group spends in the building 2 is inside the restaurant, each room, each table or each seat in the restaurant. Here, the time threshold may be set in common regardless of areas or may be set for each area. The group specification unit 27 specifies the user staying in the area, for example, when the behavior information acquisition unit 15 detects entrance and exit of the user to and from one of the areas on the basis of the behavior information acquired by the behavior information acquisition unit 15, and the like. In a case where a plurality of users stay in the area, the group specification unit 27 calculates a period during which the plurality of users stay together in the area. The group specification unit 27 registers the plurality of users as a group in a case where the period during which the users stay together exceeds a time threshold of the area. The group specification unit 27 assigns identification information unique to a group when the group specification unit 27 newly specifies the group. Here, the group specification unit 27 may register a frequency of gathering for each group. For example, when a group for which a period during which the users stay together exceeds the time threshold has already been registered, the group specification unit 27 increases the frequency of gathering of the group.

Further, the group specification unit 27 specifies the group that starts utilization of the ascending/descending facility provided in the building 2, for example, as follows. The group specification unit 27 starts processing of specifying the group, for example, when a plurality of users who start utilization of the same ascending/descending facility are detected on the basis of the behavior information acquired by the behavior information acquisition unit 15, and the like. When a group including the plurality of users has already been registered, the group specification unit 27 specifies the plurality of users as the group that starts utilization of the ascending/descending facility.

Here, also when a group including the plurality of users as a part thereof has already been registered, the group specification unit 27 may specify the plurality of users as the group that starts utilization of the ascending/descending facility. For example, the group specification unit 27 may specify the plurality of users as the group that starts utilization of the ascending/descending facility when the number of the plurality of users is equal to or larger than a set number of users set in advance. The set number of users is set in advance so that the group can be specified from part of the members. The set number of users may be set in common among all groups, may be set for each group or may be set for each number of users of the group. Alternatively, the group specification unit 27 may specify the plurality of users as the group that starts utilization of the ascending/descending facility when a ratio of the number of the plurality of users with respect to the number of users in the group is greater than a set ratio set in advance. The set ratio is set in advance so that the group can be specified from part of the members. The set ratio may be set in common among all groups or may be set for each group. The set ratio is set to, for example, a value such as ½ so that the group is specified when a majority of the members is included. Further, the group specification unit 27 may switch specification between specification by the set number of users and specification by the set ratio in accordance with, for example, the number of users in the group.

The interest information acquisition unit 20 acquires interest information of the group when the group specification unit 27 specifies a group that stays in one of the areas in the building 2. The interest information of the group is information representing a degree of interest of the group for each attribute assigned to the area. The interest information acquisition unit 20 acquires the interest information of the group, for example, on the basis of an attribute of the area in which the group stays, and the like. For example, when an attribute such as a “meeting” is assigned to the area, the interest information acquisition unit 20 acquires the interest information of the group assuming that a degree of interest is high for the attribute such as a “meeting”. Here, the attribute assigned to the area may represent the purpose of stay such as, for example, a “meeting” or may represent an available facility such as a “projector” and a “web meeting” or may represent capacity such as “up to six persons”. Further, the attribute assigned to the area may, for example, represent the purpose of stay such as, for example, “drinking and eating” or may represent a category such as a “pub” and a “family-style restaurant” or may be name of the store representing a specific store.

The interest information storage unit 21 stores the interest information acquired by the interest information acquisition unit 20 for each group. In this example, the interest information storage unit 21 stores the interest information of the group and information on a time point and a location at which the interest information is acquired in association with identification information unique to the group. Here, the information on the time point at which the interest information is acquired may be information representing hours such as, for example, a “lunch” and a “dinner”.

The destination presentation unit 22 presents the destination to the group on the basis of the interest information stored in the interest information storage unit 21 when the group specification unit 27 specifies the group that starts utilization of the ascending/descending facility provided in the building 2. The destination presentation unit 22 presents, for example, an area with a highest degree of interest of the group to the group as the destination.

Subsequently, an example of presentation of the destination to the group will be described using FIG. 24.

FIG. 24 is a view illustrating an example of presentation of the destination by the guidance system 1 according to Embodiment 5.

FIG. 24 illustrates an example of the building 2 to which the guidance system 1 is to be applied.

FIG. 24 illustrates the building 2 at a certain date. In this building 2, an office W and an office X are located in areas on the fourth floor. Further, an office Y and a meeting room M are located in areas on the third floor. Further, an office Z and a meeting room N are located in areas on the second floor.

Until this date, the guidance system 1 acquires interest information of the user A, the user B and the user C. The interest information storage unit 21 stores the office X at which the user A normally works as an attribute with the highest degree of interest for the user A. The interest information storage unit 21 stores the office Y at which the user B normally works as an attribute with the highest degree of interest for the user B. The interest information storage unit 21 stores the office Z at which the user C normally works as an attribute with the highest degree of interest for the user C.

Further, until this date, a group G including the user A, the user B and the user C as members has conducted a meeting in the meeting room N. In this event, the group specification unit 27 registers the group G on the basis of stay of the group G in the meeting room N. Further, the interest information storage unit 21 stores a “meeting” as an attribute with the highest degree of interest for the group G.

In this case, the user A, the user B and the user C are specified by the user specification unit 14 by the images captured by a plurality of cameras 12 provided on the first floor or the camera 12 inside the car 7 of the elevator 3 on which the users get. In this event, the group specification unit 27 specifies the user A, the user B and the user C as the group G by checking the users against information on members, and the like, of the registered group.

In this event, the destination presentation unit 22 reads the interest information for the group G from the interest information storage unit 21. Here, the destination presentation unit 22 reads the interest information for the specified group in preference to the interest information for individual users included in the group as members. The destination presentation unit 22 in this example presents an area with an attribute with the highest degree of interest to the group as the destination. In other words, the area with the attribute with the highest degree of interest is preferentially presented. Thus, the destination presentation unit 22 acquires a “meeting” as the attribute with the highest degree of interest of the group G. Here, the destination presentation unit 22 may present the destination to the group on the basis of availability of the meeting room. The availability of the meeting room is, for example, judged on the basis of an image, or the like, captured by the camera 12 that captures an image of inside or the entrance of the meeting room. Alternatively, the destination presentation unit 22 may acquire availability of the meeting room from outside the guidance system 1 such as, for example, a meeting room reservation system. The destination presentation unit 22 extracts an area to which a “meeting” is assigned as the attribute from the attribute storage unit 13. In this example, the destination presentation unit 22 extracts the area on the third floor to which the attribute of “meeting” is assigned and in which the available meeting room M is located. The destination presentation unit 22 presents the extracted area to the group G as the destination.

Note that the destination presentation unit 22 in this example does not present destinations on the basis of interest information of individual users included in the specified group as members. For example, when the user A is singly specified, the destination presentation unit 22 presents the area on the fourth floor in which the office X with the highest degree of interest of the user A is located to the user A as the destination. On the other hand, when the group G including the user A as a member is specified, the destination presentation unit 22 presents the area of one of the meeting rooms as the destination on the basis of the interest information of the group and does not present the area of the office X based on the interest information of the user A as the destination.

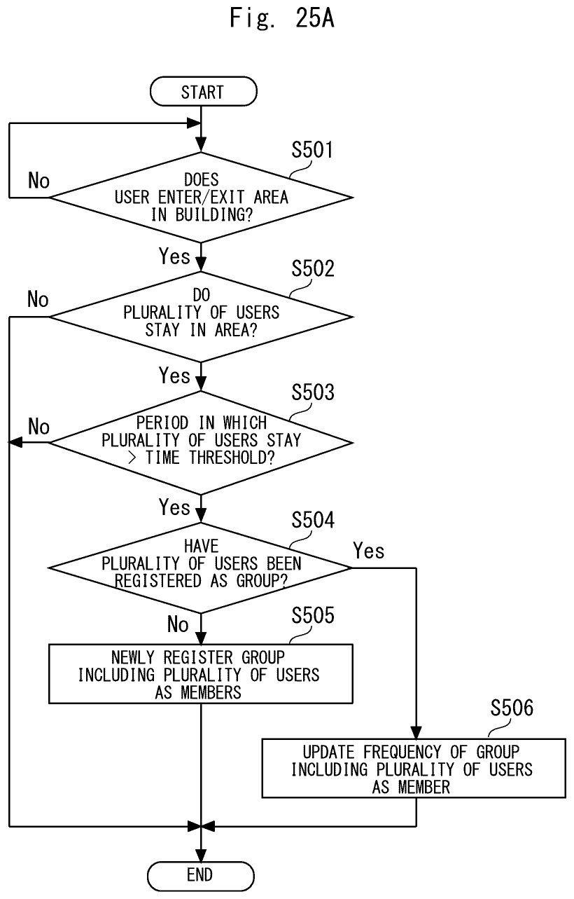

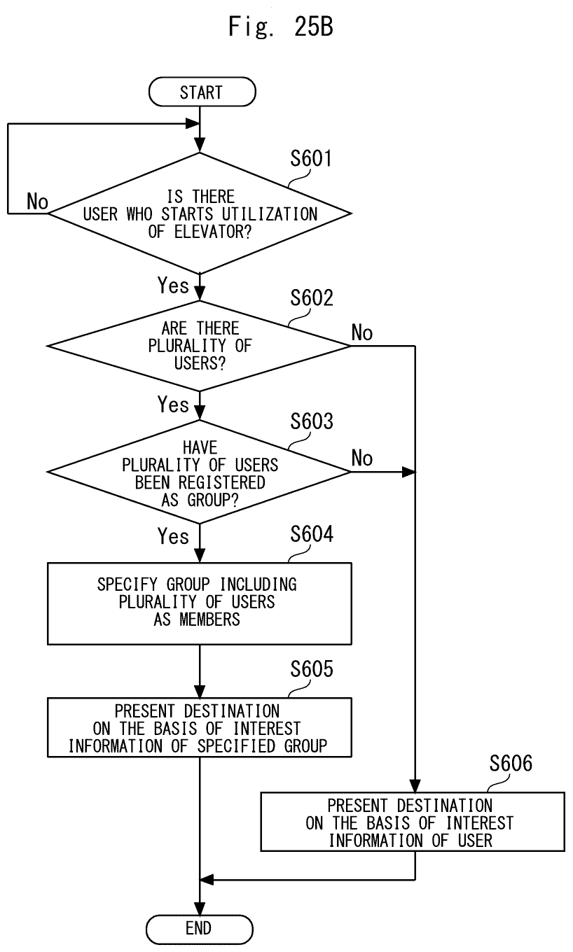

Subsequently, an example of operation of the guidance system 1 will be described using FIG. 25.

FIG. 25A and FIG. 25B are flowcharts illustrating an example of the operation of the guidance system 1 according to Embodiment 5.

FIG. 25A illustrates an example of the operation of the guidance system 1 related to registration of the group.

In step S501, the group specification unit 27 judges whether a user enters/exits one of the areas in the building 2. In a case where the judgement result is Yes, the operation of the guidance system 1 proceeds to step S502. In a case where the judgement result is No, the operation of the guidance system 1 proceeds to step S501 again.

In step S502, the group specification unit 27 judges whether a plurality of users stay in the area immediately before the user enters/exits the area for which entrance/exit of the user is detected. In a case where the judgement result is Yes, the operation of the guidance system 1 proceeds to step S503. In a case where the judgement result is No, the operation of the guidance system 1 related to registration of the group ends.

In step S503, the group specification unit 27 calculates a period that has elapsed from previous detection of entrance/exit of a user to/from the area for the area for which entrance/exit of the user is detected as a period during which the plurality of users stay together in the area. The group specification unit 27 judges whether the calculated period is longer than a time threshold. In a case where the judgement result is Yes, the operation of the guidance system 1 proceeds to step S504. In a case where the judgement result is No, the operation of the guidance system 1 related to registration of the group ends.

In step S504, the group specification unit 27 judges whether the group including the plurality of users as members has already been registered for the plurality of users who stay together in the area for which entrance/exit is detected for a period exceeding the time threshold. In a case where the judgement result is No, the operation of the guidance system 1 proceeds to step S505. In a case where the judgement result is Yes, the operation of the guidance system 1 proceeds to step S506.

In step S505, the group specification unit 27 newly registers a group including as members the plurality of users who stay together in the area for which entrance/exit is detected for a period exceeding the time threshold. In this event, the group specification unit 27 assigns identification information unique to the group. Further, the interest information acquisition unit 20 acquires interest information of the group on the basis of the attribute assigned to the area. The interest information storage unit 21 stores the acquired interest information of the group. Then, the operation of the guidance system 1 related to registration of the group ends.

In step S506, the group specification unit 27 updates a frequency of gathering of the group for the group including as members the plurality of users who stay together in the area for which entrance/exit is detected for a period exceeding the time threshold. The interest information acquisition unit 20 may update or newly acquire the interest information of the group on the basis of the attribute assigned to the area. The interest information storage unit 21 stores the interest information of the group that is updated or newly acquired. Then, the operation of the guidance system 1 related to registration of the group ends.

FIG. 25B illustrates an example of operation of the guidance system 1 related to presentation of the destination when the specified group utilizes the elevator 3 as the ascending/descending facility.

In step S601, the group specification unit 27 judges whether there is a user who starts utilization of the elevator 3 in the building 2. In a case where the judgement result is Yes, the operation of the guidance system 1 proceeds to step S602. In a case where the judgement result is No, the operation of the guidance system 1 proceeds to step S601 again.

In step S602, the group specification unit 27 judges whether there are a plurality of users who start utilization of the elevator 3. In a case where the judgement result is Yes, the operation of the guidance system 1 proceeds to step S603. In a case where the judgement result is No, the operation of the guidance system 1 proceeds to step S606.

In step S603, the group specification unit 27 judges whether a group including as members the plurality of users who start utilization of the elevator 3 is registered. In a case where the judgement result is Yes, the operation of the guidance system 1 proceeds to step S604. On the other hand, in a case where the judgement result is No, the operation of the guidance system 1 proceeds to step S606.

In step S604, the group specification unit 27 specifies the plurality of users who start utilization of the elevator 3 as a group on the basis of the information registered in advance. Then, the operation of the guidance system 1 proceeds to step S605.

In step S605, the destination presentation unit 22 refers to the interest information stored in the interest information storage unit 21 for the group specified by the group specification unit 27. The destination presentation unit 22 extracts an area of the destination of the group on the basis of the interest information that is referred to. The destination presentation unit 22 presents the extracted area to the group as the destination. Then, the operation of the guidance system 1 related to presentation of the destination ends.

In step S606, the destination presentation unit 22 refers to the interest information stored in the interest information storage unit 21 for the user specified by the user specification unit 14. The destination presentation unit 22 extracts an area of the destination of the user on the basis of the interest information that is referred to. The destination presentation unit 22 presents the extracted area to the user as the destination. Note that in a case where a plurality of users are specified, the destination presentation unit 22 extracts and presents the area of the destination for each of the users. Then, the operation of the guidance system 1 related to presentation of the destination ends.

As described above, the guidance system 1 according to Embodiment 5 includes the group specification unit 27. The group specification unit 27 specifies a group including a plurality of users specified by the user specification unit 14. The interest information acquisition unit 20 acquires interest information representing a degree of interest of the group for each attribute on the basis of a relationship between the layout and attributes of the areas and behavior information for the group specified by the group specification unit 27. Here, the areas are areas on the arrival floor judged by the floor judgement unit 19 for the users included in the group. Further, the behavior information is behavior information acquired by the behavior information acquisition unit 15 for the users included in the group. The interest information storage unit 21 stores the interest information acquired by the interest information acquisition unit 20 for each group. The destination presentation unit 22 preferentially presents an area with an attribute with a higher degree of interest to the group as the destination when the group specification unit 27 specifies the group that starts utilization of the ascending/descending facility. In this event, the destination is presented on the basis of the interest information stored in the interest information storage unit 21 for the group, and the information on the attributes stored in the attribute storage unit 13.

According to such a configuration, even in a case where a plurality of users gather and behave as a group, a more appropriate destination is presented to the group. This further improves convenience in the building 2 also for users who behave as a group. Note that in the guidance system 1, the group is guided in a similar manner to a case where individual users are guided. When the group is guided, part of the users among the members of the group may be guided.

Further, for the group for which the interest information is stored in the interest information storage unit 21, there is a case where a plurality of users included in the group are specified by the user specification unit 14 as users who start utilization of the ascending/descending facility. In this case, in a case where the number of the specified plurality of users is equal to or larger than a set number of users set in advance, the group specification unit 27 may specify the plurality of users as the group. Alternatively, in a case where a ratio of the number of the specified plurality of users with respect to the number of users in the group is greater than a ratio set in advance, the group specification unit 27 may specify the plurality of users as the group.

According to such a configuration, the guidance system 1 can present guidance to the group even in a case where not all the members of the group gather. This further improves convenience of the users who behave as a group in the building 2.

Note that the group specification unit 27 may register different groups including overlapping members. For example, the group specification unit 27 may register a group G including the user A, the user B and the user C as members, and a group H including the user A, the user B, the user C and the user D as members as groups different from each other.

Further, in a case where there are a plurality of candidates for a group to be specified, the group specification unit 27 may preferentially specify a group with a higher frequency of gathering among the registered groups as a group to be specified. For example, in a case where a frequency of gathering of the group H is higher than a frequency of gathering of the group G, when the user A, the user B and the user C start utilization of the elevator 3, the group specification unit 27 may specify these users as the group H.

Further, in a case where the user temporarily enters/exits the area, the group specification unit 27 may calculate a period during which the user stays assuming that the user does not enter/exit the area. For example, in a case where the user who is the member of the group temporarily exits the area to go to a restroom or to make a phone call, or the like, or in a case where a user other than the members of the group temporarily enters the area to contact the members, to set the facility, or the like, the group specification unit 27 calculates a period during which the users stay together in the area assuming that the user does not enter/exit the area. For example, in a case where a time interval between entrance and exit of the user to and from the area is shorter than a set interval set in advance, the group specification unit 27 judges that the user temporarily enters/exits the area. This can further improve accuracy of registration of the group.

### Embodiment 6

In the guidance system 1 in this example, the group is guided across a plurality of buildings 2.

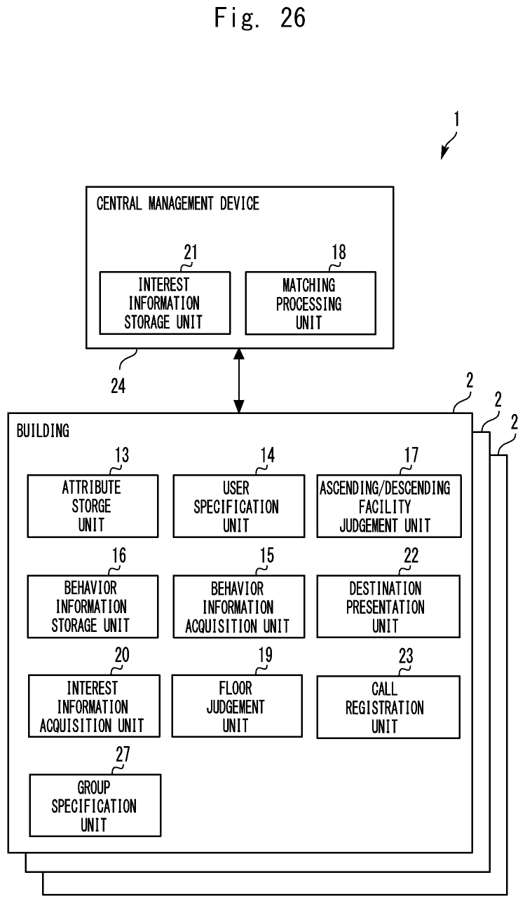

FIG. 26 is a configuration diagram of the guidance system 1 according to Embodiment 6.

In the guidance system 1, the group specification unit 27 is applied to each building 2 as a part that performs data processing. The group specification unit 27 applied to the building 2 specifies a group including a plurality of users specified by the user specification unit 14 applied to the building 2. In this example, the group specification units 27 applied to respective buildings share information on the registered group with each other. The information on the registered group may be stored in the central management device 24.

The interest information storage unit 21 integrates the interest information acquired in the respective buildings 2 and stores the integrated interest information for each group. The interest information storage unit 21 stores, for example, identification information unique to the group and the interest information of the group in association with each other.

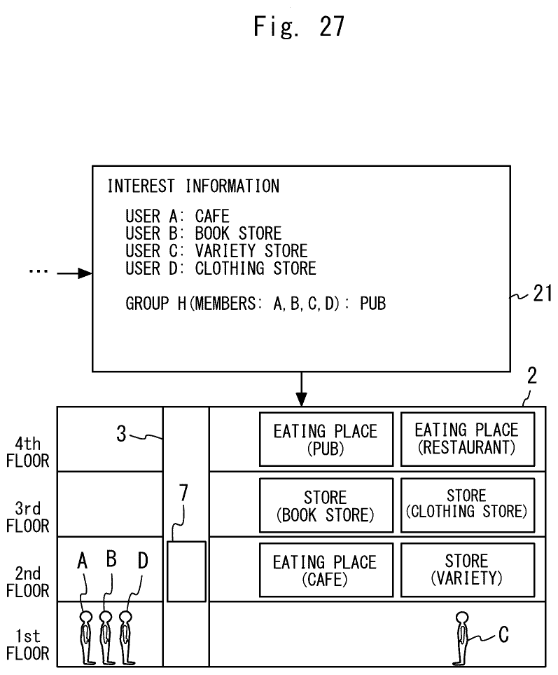

Subsequently, an example of presentation of the destination to the group will be described using FIG. 27.

FIG. 27 is a view illustrating an example of presentation of the destination by the guidance system 1 according to Embodiment 6.

FIG. 27 illustrates an example of one of the plurality of buildings 2 to which the guidance system 1 is to be applied.

FIG. 27 illustrates the building 2 at a certain date. In this building 2, a pub which is an eating place and a restaurant which is an eating place are open in areas on the fourth floor. Further, in the building 2, a book store and a clothing store are open in areas on the third floor. Still further, in the building 2, a variety store and a cafe which is an eating place are open in an area on the second floor.

Until this date, the guidance system 1 acquires interest information of the user A, the user B, the user C and the user D. The interest information storage unit 21 stores a “cafe” as an attribute with the highest degree of interest for the user A. The interest information storage unit 21 stores a “book store” as an attribute with the highest degree of interest for the user B. The interest information storage unit 21 stores a “variety store” as an attribute with the highest degree of interest for the user C. The interest information storage unit 21 stores a “clothing store” as an attribute with the highest degree of interest for the user D. The interest information is acquired on the basis of behavior information, and the like, of each user in other buildings.

Further, until this date, a group H including the user A, the user B, the user C and the user D as members has conducted a meeting at a pub in another building. In this event, the interest information storage unit 21 stores a “pub” as an attribute with the highest degree of interest for the group H. Here, ½ corresponding to a majority is set as a set ratio for the group H. In this manner, the other building in which the interest information, and the like, of the group is acquired is an example of a first building. A first group specification unit is the group specification unit 27 applied to the first building. In this example, each member of the group H visits the building 2 illustrated in FIG. 27 for the first time.

In this case, the user A, the user B and the user D are specified by the user specification unit 14 by images captured by a plurality of cameras 12 provided on the first floor or the camera 12 inside the car 7 of the elevator 3 on which the users get. In this event, the group specification unit 27 checks the users against information on members, and the like, of the registered group. Here, the number of users of the user A, the user B and the user D reach a majority of the members of the group H. Thus, the group specification unit 27 specifies the user A, the user B and the user D as the group H.

In this event, the destination presentation unit 22 reads the interest information for the group H from the interest information storage unit 21. The destination presentation unit 22 in this example presents an area with an attribute with the highest degree of interest to the group as the destination. Thus, the destination presentation unit 22 acquires a “pub” as the attribute with the highest degree of interest of the group H. In this example, the destination presentation unit 22 extracts the area on the fourth floor in which the store to which the attribute of “pub” is assigned is open. The destination presentation unit 22 presents the extracted area to the group H as the destination. In this manner, the building 2 in FIG. 27 in which presentation of the destination to the group, and the like, are performed is an example of a second building. A second group specification unit is the group specification unit 27 applied to the second building. Note that the second building does not have to be a building visited by the group H for the first time. In the second building, interest information, and the like, of the group H may be acquired in the past.

Note that the destination presentation unit 22 may acquire availability of the store, reservation information of the specified group, and the like, from outside of the guidance system 1 such as, for example, a store utilization reservation system. The destination presentation unit 22 may extract an area of the destination of the group using the acquired information.

As described above, the guidance system 1 according to Embodiment 6 includes the group specification unit 27 corresponding to each building. Each group specification unit 27 specifies a group including a plurality of users specified by the user specification unit 14 applied to the corresponding building. The interest information acquisition unit 20 acquires interest information representing a degree of interest of the group for each attribute on the basis of a relationship between layout and attributes of the areas in the building 2 and the behavior information for the group specified by the group specification unit 27 of one of the buildings 2. The interest information storage unit 21 stores the interest information acquired by the interest information acquisition unit 20 for each group. When the group specification unit 27 of the building 2 specifies a group that starts utilization of the ascending/descending facility provided in one of the building 2, the destination presentation unit 22 preferentially presents an area with an attribute with a higher degree of interest in the building 2 to the group as the destination. Here, the destination is presented by the destination presentation unit 22 on the basis of the interest information stored in the interest information storage unit 21 for the group and the information on the attributes stored in the attribute storage unit 13 of the building 2. Further, the destination is presented by the destination presentation unit 22 by utilizing part or all of the interest information acquired in the respective buildings.

According to such a configuration, even in a case where a plurality of users gather and behave as a group, a more appropriate destination can be presented to the group. This further improves convenience of the users who behave as a group in the building 2. Further, the interest information of the group is shared among the plurality of buildings 2, so that the guidance system 1 can present the destination on the basis of interest also for a group which visits the building 2 for the first time.

Further, for a group for which interest information is stored in the interest information storage unit 21, there is a case where a plurality of users included in the group are specified by the user specification unit 14 of the building 2 as users who start utilization of the ascending/descending facility of one of the buildings 2. In this case, the group specification unit 27 of the building 2 may specify the plurality of users as the group in a case where the number of the specified plurality of users is equal to or larger than a set number of users set in advance. Alternatively, the group specification unit 27 of the building 2 may specify the plurality of users as the group in a case where a ratio of the number of the specified plurality of users with respect to the number of users in the group is greater than a ratio set in advance.

According to such a configuration, the guidance system 1 can present guidance to the group even in a case where not all the members of the group gather. This further improves convenience of users who behave as a group in a plurality of buildings 2.

### Embodiment 7

In the guidance system 1 in this example, the interest information of the group is provided to the external system 99.

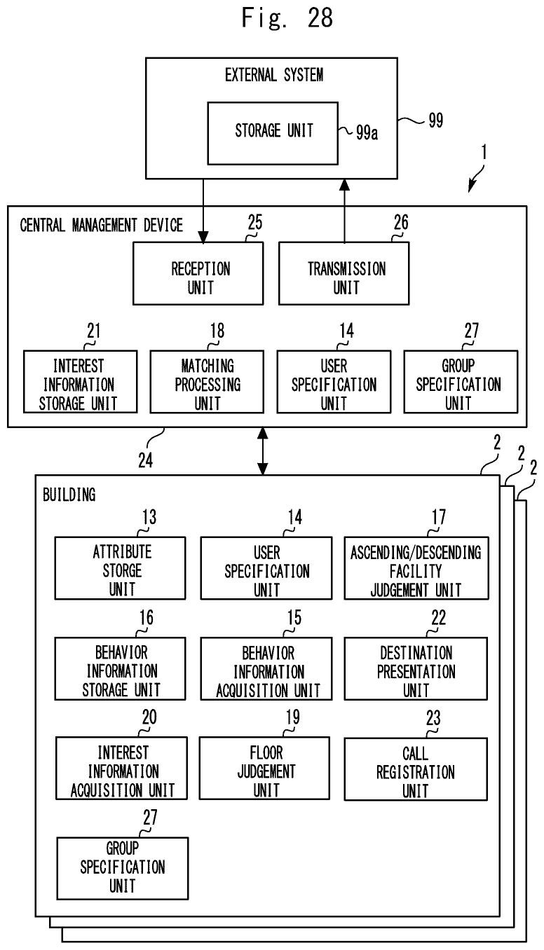

FIG. 28 is a configuration diagram of the guidance system 1 according to Embodiment 7.

The central management device 24 includes the group specification unit 27. The group specification unit 27 of the central management device 24 specifies a group including a plurality of users specified by the user specification unit 14 of the central management device 24. The group specification unit of the central management device 24 is an example of a third group specification unit. In this example, the group specification unit 27 of each building and the group specification unit 27 of the central management device 24 share information of the registered groups with each other. The information on the registered groups may be stored in the central management device 24.

The central management device 24 provides information to the external system 99, for example, as follows. The reception unit 25 of the central management device 24 receives images of a plurality of users from the external system 99. The user specification unit 14 of the central management device 24 specifies each user on the basis of the images received from the external system 99. The group specification unit 27 of the central management device 24 judges whether the group including as members the plurality of users specified by the user specification unit 14 is registered. In a case where the plurality of users are registered as the group, the group specification unit 27 specifies the group including the plurality of users as members. Further, the transmission unit 26 reads interest information for the specified group from the interest information storage unit 21, specifies an attribute with the highest degree of interest corresponding to each area on each floor on a bird's-eye map of the building to which the external system 99 is to be applied as interest information and transmits candidates for the destination in the building to the external system 99. The transmission unit 26 transmits information representing an attribute with the highest degree of interest of the group specified by the images to the external system 99.

The external system 99 receives the candidates for the destination of the specified group from the central management device 24. The external system 99 presents the destination to the group on the basis of the received candidates for the destination. Note that the building to which the external system 99 is to be applied does not have to be a building visited by the user for the first time.

As described above, the guidance system 1 according to Embodiment 7 includes the group specification unit 27 corresponding to the building 2 to which the guidance system 1 is to be applied, and the group specification unit 27 of the central management device 24. The interest information acquisition unit 20 acquires interest information representing a degree of interest of the group for each attribute on the basis of layout and attributes of areas and behavior information for the specified group. The interest information storage unit 21 stores the interest information acquired by the interest information acquisition unit 20 for each group. The transmission unit 26 transmits candidates with high degrees of interest stored in the interest information storage unit 21 as the interest information for the group to the external system 99 for the group specified by the group specification unit 27 of the central management device 24.

According to such a configuration, even in a case where a plurality of users gather and behave as a group, a more appropriate destination can be presented to the group. This further improves convenience also for users who behave as a group in a plurality of buildings 2 to which the guidance system 1 is applied and the building to which the external system 99 is applied.

Further, for a group for which interest information is stored in the interest information storage unit 21, there is a case where a plurality of users included in the group are specified by the user specification unit 14 of the central management device 24 in the building to which the external system 99 is to be applied. In this case, the group specification unit 27 of the central management device 24 may specify the plurality of users as the group in a case where the number of the specified plurality of users is equal to or larger than a set number of users set in advance. Alternatively, the group specification unit 27 of the central management device 24 may specify the plurality of users as the group in a case where a ratio of the number of the specified plurality of users with respect to the number of users in the group is greater than a ratio set in advance.

According to such a configuration, the guidance system 1 can present guidance to the group even in a case where not all the members of the group gather. This further improves convenience of users who behave as a group.

### Embodiment 8

The guidance system 1 in this example may employ a configuration illustrated in one of FIG. 1, FIG. 19, FIG. 21, FIG. 23, FIG. 26 or FIG. 28 or may employ a configuration which is a combination of these.

In the guidance system 1 in this example, whether or not the destination may be presented on the basis of interest information of the user or the group is selected by, for example, the user, members of the group, or the like.

The interest information storage unit 21 stores whether or not the destination may be presented on the basis of the interest information in association with the interest information as switchable information. Whether or not the destination may be presented on the basis of the interest information is selected by a user, members of the group, or the like, regarding the interest information, to whom the destination is to be presented. The user, and the like, to whom the destination is to be presented switch setting from setting that the destination may be presented to setting that the destination must not be presented or from setting that the destination must not be presented to setting that the destination may be presented, for example, through a mobile terminal such as a smartphone that can be connected to the guidance system 1 or a user interface of the ascending/descending facility such as the hall operating panel 9. When the setting is made such that the destination must not be presented on the basis of the interest information, the guidance system 1 does not present the destination on the basis of the interest information. In other words, when the setting is made such that the destination must not be presented on the basis of the interest information, the destination presentation unit 22 does not present the destination to the user, the group, or the like, regarding the interest information. Further, in a case where the guidance system 1 coordinates with the external system 99, for example, when the setting is made such that the destination must not be presented on the basis of the interest information, the guidance system 1 does not transmit information on the user, the group, or the like, regarding the interest information to the external system 99.

A mask of presentation of the destination can be applied for the user or the group for which the setting is made such that the destination must not be presented on the basis of interest information. This avoids undesirable presentation of the destination to the user or the group and can protect information on presentation of the destination.

### INDUSTRIAL APPLICABILITY

The guidance system according to the present disclosure can be applied to a building including a plurality of floors.

### REFERENCE SIGNS LIST

1 Guidance system, 2, 2a, 2b, 2c, 2d Building, 3 Elevator, 4 Escalator, 5 Stairs, 6 Hoistway, 7 Car, 8 Control panel, 9 Hall operating panel, 10 Car operating panel, 10a Display panel, 10b Destination button, 11 Group management device, 12 Camera, 13 Attribute storage unit, 14 User specification unit, 15 Behavior information acquisition unit, 16 Behavior information storage unit, 17 Ascending/descending facility judgement unit, 18 Matching processing unit, 19 Floor judgement unit, 20 Interest information acquisition unit, 21 Interest information storage unit, 22 Destination presentation unit, 23 Call registration unit, 24 Central management device, 25 Reception unit, 26 Transmission unit, 27 Group specification unit, 99 External system, 99a Storage unit, 100a Processor, 100b Memory, 200 Dedicated hardware

1.-20. (canceled)

21. A guidance system comprising:
processing circuitry
to store attributes for each area for each of a plurality of floors of a building;
to specify a user in the building on a basis of an image or images captured by at least one of a plurality of cameras provided in the building;
to, when the user specified by the processing circuitry moves from a departure floor to an arrival floor among the plurality of floors by utilizing one of one or more ascending/descending facilities provided in the building, judge the arrival floor of the user on a basis of an image or images captured by at least one of the plurality of cameras;
to acquire behavior information representing behavior of the user on the arrival floor judged by the processing circuitry on a basis of an image or images captured by one of the plurality of cameras for the user specified by the processing circuitry;
to acquire interest information representing a degree of interest of the user for each attribute on a basis of a relationship between layout and attributes of areas on the arrival floor judged by the processing circuitry and the behavior information acquired by the processing circuitry for the user specified by the processing circuitry;
to store the interest information acquired by the processing circuitry for each user; and
to, when the processing circuitry specifies a user who starts utilization of one of the one or more ascending/descending facilities, preferentially present an area with an attribute with a higher degree of interest to the user as a destination on a basis of the interest information stored in the processing circuitry for the user and information on the attributes stored in the processing circuitry.

22. The guidance system according to claim 21,
wherein, in a case where the one or more ascending/descending facilities include a plurality of ascending/descending facilities,
when the user specified by the processing circuitry starts utilization of one of the plurality of ascending/descending facilities, the processing circuitry judges an ascending/descending facility to be utilized by the user on a basis of an image or images captured by at least one of the plurality of cameras, and
in a case where the processing circuitry judges two or more ascending/descending facilities as a facility to be utilized by the user specified by the processing circuitry as the same user, the processing circuitry specifies the user who utilizes the two more ascending/descending facilities as users different from each other after extracting a difference in a feature amount or feature amounts.

23. The guidance system according to claim 21,
wherein the processing circuitry specifies a group including a plurality of users specified by the processing circuitry,
the processing circuitry acquires interest information representing a degree of interest of the group for each attribute on a basis of a relationship between layout and attributes of areas on the arrival floor judged by the processing circuitry for the users included in the group and the behavior information acquired by the processing circuitry for the users included in the group, for the group specified by the processing circuitry,
the processing circuitry stores the interest information acquired by the processing circuitry for each group, and
when the processing circuitry specifies a group that starts utilization of one of the one or more ascending/descending facilities, the processing circuitry preferentially presents an area with an attribute with a higher degree of interest to the group as a destination on a basis of the interest information stored in the processing circuitry for the group and the information on the attributes stored in the processing circuitry.

24. The guidance system according to claim 23,
wherein, for a group for which interest information is stored in the processing circuitry, when a number of a plurality of users who start utilization of one of the one or more ascending/descending facilities, who are specified by the processing circuitry and who are included in the group is equal to or larger than a number of users set in advance, the processing circuitry specifies the plurality of users as the group.

25. The guidance system according to claim 23,
wherein, for a group for which interest information is stored in the processing circuitry, when a ratio of a number of a plurality of users who start utilization of one of the one or more ascending/descending facilities, who are specified by the processing circuitry and who are included in the group, with respect to a number of users in the group is greater than a ratio set in advance, the processing circuitry specifies the plurality of users as the group.

26. The guidance system according to claim 21, wherein,
in a case where the one or more ascending/descending facilities include an elevator,
the processing circuitry automatically registers call to a destination floor including the destination presented by the processing circuitry, in the elevator.

27. A guidance system comprising:
first processing circuitry
to store attributes for each area for each of a plurality of floors of a first building,
to specify a user in the first building on a basis of an image or images captured by at least one of a plurality of first cameras provided in the first building,
to, when the user specified by the first processing circuitry moves from a departure floor to an arrival floor among the plurality of floors of the first building by utilizing one of one or more ascending/descending facilities provided in the first building, judge the arrival floor of the user on a basis of an image or images captured by at least one of the plurality of cameras,
to acquire behavior information representing behavior of the user on the arrival floor judged by the first processing circuitry on a basis of an image or images captured by at least one of the plurality of first cameras for the user specified by the first processing circuitry, and
to acquire interest information representing a degree of interest of the user for each attribute on a basis of a relationship between layout and attributes of areas on the arrival floor judged by the first processing circuitry and the behavior information acquired by the first processing circuitry for the user specified by the first processing circuitry;
central processing circuitry
to store the interest information acquired by the first processing circuitry for each user; and
second processing circuitry
to store attributes for each area for each of a plurality of floors of a second building,
to specify a user in the second building on a basis of an image or images captured by at least one of a plurality of second cameras provided in the second building, and
to, when the second processing circuitry specifies a user who starts utilization of one of one or more ascending/descending facilities provided in the second building, preferentially present an area with an attribute with a higher degree of interest for the user to the user as a destination in the second building by utilizing one or both of the interest information acquired in the first building and the interest information acquired in the second building, on a basis of the interest information stored in the central processing circuitry for the user and information on the attributes stored in the second processing circuitry.

28. The guidance system according to claim 27,
wherein, in a case where the user specified by the first processing circuitry is the same as the user specified by the second processing circuitry, the central processing circuitry cause the first processing circuitry and the second processing circuitry to specify the specified user as users different from each other after extracting a difference in a feature amount or feature amounts.

29. The guidance system according to claim 27,
wherein the first processing circuitry specifies a group including a plurality of users specified by the first processing circuitry,
the second processing circuitry specifies a group including a plurality of users specified by the second processing circuitry,
the first processing circuitry acquires interest information representing a degree of interest of the group for each attribute on a basis of a relationship between layout and attributes of areas on the arrival floor judged by the first processing circuitry for the users included in the group and the behavior information acquired by the first processing circuitry for the users included in the group, for the group specified by the first processing circuitry, the central processing circuitry stores the interest information acquired by the first processing circuitry for each group, and
when the second processing circuitry specifies a group which starts utilization of one of the one or more ascending/descending facilities provided in the second building, the second processing circuitry preferentially presents an area with an attribute with a higher degree of interest for the group to the group as a destination in the second building by utilizing one or both of the interest information acquired in the first building and the interest information acquired in the second building, on a basis of the interest information stored in the central processing circuitry for the group and information on the attributes stored in the second processing circuitry.

30. The guidance system according to claim 29,
wherein, for a group for which interest information is stored in the central processing circuitry, when a number of a plurality of users who start utilization of one of the one or more ascending/descending facilities provided in the second building, who are specified by the second processing circuitry and who are included in the group is equal to or larger than a number of users set in advance, the second processing circuitry specifies the plurality of users as the group.

31. The guidance system according to claim 29,
wherein, for a group for which interest information is stored in the central processing circuitry, when a ratio of a number of a plurality of users who start utilization of one of the one or more ascending/descending facilities provided in the second building, who are specified by the second processing circuitry and who are included in the group, with respect to a number of users in the group is greater than a ratio set in advance, the second processing circuitry specifies the plurality of users as the group.

32. The guidance system according to claim 27,
wherein, in a case where the one or more ascending/descending facilities in the second building include an elevator,
the second processing circuitry automatically registers call to a floor including the destination presented by the second processing circuitry, in the elevator.

33. A guidance system comprising:
first processing circuitry
to store attributes for each area for each of a plurality of floors of a first building,
to specify a user in the first building on a basis of an image or images captured by at least one of a plurality of first cameras provided in the first building,
to, when the user specified by the first processing circuitry moves from a departure floor to an arrival floor among the plurality of floors of the first building by utilizing one of one or more ascending/descending facilities provided in the first building, judge the arrival floor of the user on a basis of an image or images captured by at least one of the plurality of first cameras,
to acquire behavior information representing behavior of the user on the arrival floor judged by the first processing circuitry on a basis of an image or images captured by at least one of the plurality of first cameras for the user specified by the first processing circuitry, and
to acquire interest information representing a degree of interest of the user for each attribute on a basis of a relationship between layout and attributes of areas on the arrival floor judged by the first processing circuitry and the behavior information acquired by the first processing circuitry for the user specified by the first processing circuitry; and
central processing circuitry
to store the interest information acquired by the first processing circuitry for each user,
to receive an image or images of a user who starts utilization of one of one or more ascending/descending facilities provided in a third building from an external system comprising a storage to store and update each of a plurality of floors of the third building, the external system presenting a destination in accordance with a degree of interest of the user in the third building,
to specify a user on a basis of the image received by the central processing circuitry, and
to transmit a candidate with a high degree of interest stored in the central processing circuitry as interest information for the user to the external system for the user specified by the central processing circuitry.

34. The guidance system according to claim 33,
wherein the first processing circuitry specifies a group including a plurality of users specified by the first processing circuitry,
the central processing circuitry specifies a group including a plurality of users specified by the central processing circuitry,
the first processing circuitry acquires interest information representing a degree of interest of the group for each attribute on a basis of a relationship between layout and attributes of areas on the arrival floor judged by the first processing circuitry for the users included in the group and the behavior information acquired by the first processing circuitry for the users included in the group for the group specified by the first processing circuitry,
the central processing circuitry stores the interest information acquired by the first processing circuitry for each group, and
the central processing circuitry transmits a candidate with a high degree of interest stored in the central processing circuitry as interest information for the group to the external system for the group specified by the central processing circuitry.

35. The guidance system according to claim 34,
wherein, for a group for which interest information is stored in the central processing circuitry, in a case where a number of the plurality of users included in the group specified by the central processing circuitry in the third building is equal to or larger than a number of users set in advance, the central processing circuitry specifies the plurality of users as the group.

36. The guidance system according to claim 34,
wherein, for a group for which interest information is stored in the central processing circuitry, in a case where a ratio of a number of the plurality of users included in the group specified by the central processing circuitry in the third building with respect to a number of users in the group is greater than a ratio set in advance, the central processing circuitry specifies the plurality of users as the group.

37. The guidance system according to claim 33,
wherein one of the first processing circuitry or the central processing circuitry acquires interest information of the user or the group every time one of the first processing circuitry or the central processing circuitry completes acquisition of the behavior information on the arrival floor of the user or the group.

38. The guidance system according to claim 33,
wherein one of the first processing circuitry or the central processing circuitry stores the behavior information acquired by one of the first processing circuitry or the central processing circuitry for each user, and
one of the first processing circuitry or the central processing circuitry reads the behavior information for each user or group from one of the first processing circuitry or the central processing circuitry at a timing set in advance and acquires interest information of the user or the group on a basis of the read behavior information.

39. The guidance system according to claim 33,
wherein one of the first processing circuitry or the central processing circuitry learns a model that derives behavior information from an image or images of a user or users or groups using a machine learning method and acquires behavior information of a user or a group from the image or images of the user or the group on a basis of the learned model.

40. The guidance system according to claim 36,
wherein at least one of the first processing circuitry or the central processing circuitry stores information regarding whether or not a destination may be presented on a basis of the stored interest information in association with the interest information as switchable information.
